(19) United States
(12) Patent Application Publication
(10) Pub. No.: US 2024/0354297 A1
(43) Pub. Date: Oct. 24, 2024

(54) SYSTEM AND METHOD OF INTELLIGENT TRANSLATION OF METADATA LABEL NAMES AND MAPPING TO NATURAL LANGUAGE UNDERSTANDING

(71) Applicant: BOOMI, LP, Chesterbrook, PA (US)

(72) Inventors: Daniel Schwartz, Marlton, NJ (US); Michael J. Morton, Morrisville, NC (US)

(73) Assignee: BOOMI, LP, Chesterbrook, PA (US)

(21) Appl. No.: 18/754,821

(22) Filed: Jun. 26, 2024

Related U.S. Application Data
(63) Continuation of application No. 16/737,756, filed on Jan. 8, 2020, now abandoned.
(60) Provisional application No. 62/909,151, filed on Oct. 1, 2019.

(51) Int. Cl. G06F 16/242; G06F 16/21; G06F 16/248; G06F 16/25; G06F 16/901; G06F 21/62

(52) U.S. Cl. CPC G06F 16/2428; G06F 16/214; G06F 16/248; G06F 16/25; G06F 16/9024; G06F 21/6218

(57) ABSTRACT

An information handling system operating a data integration protection assistance system may comprise a processor linking first and second data set field names identified within a data integration process for transferring a data set field value identified by the first data field name at a source location to a destination location for storage under the second data field name. The processor may receive a user instruction to label data set field names incorporating a search term as sensitive private individual data, determine the first data set field name incorporates the search term and the second data set field name does not incorporate the search term, and label both the first and second data set field names as sensitive private individual data. A graphical user interface may display the first and second data set field names, to track migration of data set field values containing sensitive personal information, despite renaming.

This application claims priority to U.S. application Ser. No. 16/737,756, entitled “SYSTEM AND METHOD OF INTELLIGENT TRANSLATION OF METADATA LABEL NAMES AND MAPPING TO NATURAL LANGUAGE UNDERSTANDING,” filed on Jan. 8, 2020; which claims priority to U.S. Provisional Application No. 62/909,151, entitled “SYSTEM AND METHOD OF INTELLIGENT TRANSLATION OF METADATA LABEL NAMES AND MAPPING TO NATURAL LANGUAGE UNDERSTANDING,” filed on Oct. 1, 2019, both of which are incorporated herein by reference in their entirety.

### FIELD OF THE DISCLOSURE

The present disclosure relates generally to a system and method for deploying and executing customized data integration processes. More specifically, the present disclosure relates to identification and tracking of data model fieldnames associated with data model values likely to include sensitive personal information as they are manipulated during a customized data integration process.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), a head-mounted display device, server (e.g., blade server or rack server), a network storage device, a network storage device, a switch router or other network communication device, other consumer electronic devices, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components. Further, the information handling system may include telecommunication, network communication, and video communication capabilities and require communication among a variety of data formats.

### BRIEF DESCRIPTION OF THE DRAWINGS

The present disclosure will now be described by way of example with reference to the following drawings in which:

FIG. 1 is a block diagram illustrating an information handling system according to an embodiment of the present disclosure;

FIG. 2 is a block diagram illustrating a simplified integration network according to an embodiment of the present disclosure;

FIG. 3A is a graphical diagram illustrating a user-generated flow diagram of an integration process according to an embodiment of the present disclosure;

FIG. 3B is a graphical diagram illustrating a user-generated flow diagram of an integration process providing added security according to an embodiment of the present disclosure;

FIG. 4A is a graphical diagram illustrating a user interface for entering terms describing data model fieldnames associated with values likely to contain potentially sensitive information according to an embodiment of the present disclosure;

FIG. 4B is a graphical diagram illustrating a user interface for entering terms describing data model fieldnames associated with values not likely to contain potentially sensitive information according to an embodiment of the present disclosure;

FIG. 5 is a graphical diagram illustrating mapping between multiple data model fieldnames for a single data model field value throughout an integration process according to an embodiment of the present disclosure;

FIG. 6 is a graphical user interface for describing data model field values labeled as sensitive information according to an embodiment of the present disclosure;

FIG. 7 is a graphical diagram illustrating a graphical user interface for viewing a proportion of data model field values labeled as including sensitive personal information according to an embodiment of the present disclosure;

FIG. 8 is a flow diagram illustrating a method of mapping multiple data model fieldnames for a single data model field value together according to an embodiment of the present disclosure;

FIG. 9 is a flow diagram illustrating a method of labeling a data model fieldname as sensitive personal information according to an embodiment of the present disclosure; and

FIG. 10 is a flow diagram illustrating a method of generating a report describing properties of a dataset labeled as sensitive personal information according to an embodiment of the present disclosure.

The use of the same reference symbols in different drawings may indicate similar or identical items.

### DETAILED DESCRIPTION

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Conventional software development and distribution models have involved development of an executable software application, and distribution of a computer-readable medium, or distribution via download of the application from the worldwide web to an end user. Upon receipt of the downloaded application, the end user executes installation files to install the executable software application on the user's personal computer (PC), or other information handling system. When the software is initially executed, the application may be further configured/customized to recognize or accept input relating to aspects of the user's PC, network, etc., to provide a software application that is customized for a particular user's computing system. This simple, traditional approach has been used in a variety of contexts, with software for performing a broad range of different functionality. While this model might sometimes be satisfactory for individual end users, it is undesirable in sophisticated computing environments.

Today, most corporations or other enterprises have sophisticated computing systems that are used both for internal operations, and for communicating outside the enterprise's network. Much of present day information exchange is conducted electronically, via communications networks, both internally to the enterprise, and among enterprises. Accordingly, it is often desirable or necessary to exchange information/data between distinctly different computing systems, computer networks, software applications, etc. In many instances, these disparate computing networks, enterprises, or systems are located in a variety of different countries around the world. The enabling of communications between diverse systems/networks/applications in connection with the conducting of business processes is often referred to as “business process integration.” In the business process integration context, there is a significant need to communicate between different software applications/systems within a single computing network, e.g. between an enterprise's information warehouse management system and the same enterprise's purchase order processing system. There is also a significant need to communicate between different software applications/systems within different computing networks, e.g. between a buyer's purchase order processing system, and a seller's invoicing system. Some of these different software applications/systems may be cloud-based, with physical servers located in several different countries, cities, or other geographical locations around the world. As data is integrated between and among these cloud-based platforms, datasets may be stored (e.g., temporarily or indefinitely) in some form at physical servers in these various geographical locations.

Relatively recently, systems have been established to enable exchange of data via the Internet, e.g. via web-based interfaces for business-to-business and business-to-consumer transactions. For example, a buyer may operate a PC to connect to a seller's website to provide manual data input to a web interface of the seller's computing system, or in higher volume environments, a buyer may use an executable software application known as EDI Software, or Business-to-Business Integration Software to connect to the seller's computing system and to deliver electronically a business “document,” such as a purchase order, without requiring human intervention to manually enter the data. Such software applications are available in the market today. These applications are typically purchased from software vendors and installed on a computerized system owned and maintained by the business, in this example, the buyer. The seller will have a similar/complementary software application on its system, so that the information exchange may be completely automated in both directions. In contrast to the present disclosure, these applications are purchased, installed and operated on the user's local system. Thus, the user typically owns and maintains its own copy of the system, and configures the application locally to connect with its trading partners.

In both the traditional and more recent approaches, the executable software application is universal or “generic” as to all trading partners before it is received and installed within a specific enterprise's computing network. In other words, it is delivered to different users/systems in identical, generic form. The software application is then installed within a specific enterprise's computing network (which may include data centers, etc., physically located outside of an enterprises' physical boundaries). After the generic application is installed, it is then configured and customized for a specific trading partner after which it is ready for execution to exchange data between the specific trading partner and the enterprise. For example, Walmart® may provide on its website specifications of how electronic data such as Purchase Orders and Invoices must be formatted for electronic data communication with Walmart, and how that data should be communicated with Walmart®. A supplier/enterprise is then responsible for finding a generic, commercially available software product that will comply with these communication requirements and configuring it appropriately. Accordingly, the software application will not be customized for any specific supplier until after that supplier downloads the software application to its computing network and configures the software application for the specific supplier's computing network, etc. Alternatively, the supplier may engage computer programmers to create a customized software application to meet these requirements, which is often exceptionally time-consuming and expensive.

Recently, systems and software applications have been established to provide a system and method for on-demand creation of customized software applications in which the customization occurs outside of an enterprise's computing network. These software applications are customized for a specific enterprise before they arrive within the enterprise's computing network, and are delivered to the destination network in customized form. The Dell Boomi® Application is an example of one such software application. With Dell Boomi® and other similar applications, an employee within an enterprise can connect to a website using a specially configured graphical user interface to visually model a business integration process via a flowcharting process, using only a web browser interface. During such a modeling process, the user would select from a predetermined set of process-representing visual elements that are stored on a remote server, such as the web server. By way of an example, the integration process could enable a bi-directional exchange of data between internal applications of an enterprise, between internal enterprise applications and external trading partners, or between internal enterprise applications and applications running external to the enterprise.

A customized data integration software application creation system in an embodiment may allow a user to create a customized data integration software application by modeling a data integration process flow using a visual user interface. A modeled data integration process flow in embodiments of the present disclosure may model actions taken on data elements pursuant to executable code instructions without displaying the code instructions themselves. In such a way, the visual user interface may allow a user to understand the high-level summary of what executable code instructions achieve, without having to read or understand the code instructions themselves. Similarly, by allowing a user to insert visual elements representing portions of an integration process into the modeled data integration process flow displayed on the visual user interface, embodiments of the present disclosure allow a user to identify what she wants executable code instructions to achieve without having to write such executable code instructions.

Once a user has chosen what she wants an executable code instruction to achieve in embodiments herein, the code instructions capable of achieving such a task may be generated. Code instructions for achieving a task can be written in any number of languages and/or adhere to any number of standards, often requiring a code writer to have extensive knowledge of computer science and languages. The advent of open-standard formats for writing code instructions that are both human-readable and machine executable have made the writing of code instructions accessible to individuals that do not have a high level knowledge of computer science. Such open-standard, human-readable, data structure formats include extensible markup language (XML) and JavaScript Object Notification (JSON). Because code instructions adhering to these open-standard formats are more easily understood by non-specialists, many companies have moved to the use of code instructions adhering to these formats in constructing their data repository structures and controlling the ways in which data in these repositories may be accessed by both internal and external agents. In order to execute code instructions for accessing data at such a repository during a business integration process, the code instructions of the business integration process in some embodiments herein may be written in accordance with the same open-standard formats or other known, or later-developed standard formats.

In addition to the advent of open-standard, human-readable, machine-executable code instructions, the advent of application programming interfaces (APIs) designed using such open-standard code instructions have also streamlined the methods of communication between various software components. An API may operate to communicate with a backend application to identify an action to be taken on a dataset that the backend application manages, or which is being transmitted for management to the backend application. Such an action and convention for identifying the dataset or its location may vary among APIs and their backend applications. For example, datasets may be modeled according to user-supplied definitions. Each dataset may contain a user-defined data model fieldname, which may describe a type of information. Each user-defined data model fieldname may be associated with a data model field value. In other words, datasets may be modeled using a fieldname: value pairing. For example, a data model for a customer named John Smith may include a first data model fieldname “f_name” paired with a first data model field value “John,” and a second data model fieldname “l_name” paired with a second data model field value “Smith.” A user in an embodiment may define any number of such data model fieldname/value pairs to describe a user. Other example data model fieldnames in embodiments may include “dob” to describe date of birth, “ssn” to describe social security number, “phone” to describe a phone number, or “hair,” “race,” and “reward.”

In embodiments described herein, multiple APIs or backend applications accessed via a single integration process may operate according to differing coding languages, data model structures, data model field naming conventions or standards. Different coding languages may use different ways of describing routines, data structures, object classes, variables, or remote calls that may be invoked and/or handled during business integration processes that involve data model field values managed by the backend applications such APIs serve. Thus, a single data model field value may be described in a single integration process using a plurality of data model fieldnames, each adhering to the naming conventions set by the APIs, applications, enterprises, or trading partners through or among which the data model field value is programmed to integrate.

A user interacting with such an API for a backend application may identify such data model field values based on a description that may or may not include the actual data model fieldname of the data model field value. In some circumstances, a data model field value may be identified through a search mechanism, or through navigation through a variety of menus, for example. The code sets incorporating the actual data model fieldname for the data model field value may be automatically generating based on this user interaction with an API. In other embodiments, the data model field value may be identified in a similar way through interaction with the visual integration process flow user interface described herein. For example, the user may create two or more connector visual elements, with each connector element representing a process taken by a different application (e.g., Salesforce™, or NetSuite™). Because each of such connector elements may describe actions taken by a different application, and different applications may adhere to differing code languages, each of a plurality of code sets generated based on these user-generated connector visual elements may be written in a different code set, and may identify data model field values using different naming conventions, or storage structures. Thus, the code instructions for retrieving a given data model field value from a first application may describe that data model field value using a completely different data model fieldname than the code instructions for transmitting the same data model field value to a second application.

In embodiments described herein, a runtime engine may be created for execution of each of these code instructions written based on the user-modeled business integration process. The runtime engine, and all associated code instructions or code sets may be transmitted to an end user for execution at the user's computing device, or enterprise system, and potentially, behind the user's firewall. Because the user does not write the code instructions executed by the runtime engine, the user may not know the locations of servers through which the data to be integrated may pass during execution of the runtime engine, or the ways in which data model field values may be transformed (e.g., given a different data model fieldname) therein. As described above, the data model field values integrated during execution may pass through any number of servers, which may be located in various locations around the world. Further, the contents of these data model field values may include sensitive information (e.g., personal, secure information, or Personal Identity Information as defined within the GDPR), which may not be readily apparent based on the metadata associated with the data model field values, or the data model fieldnames given to the data model field values by various applications involved in the integration process. A method is needed to identify, label, and track the ways in which such sensitive information is handled throughout the integration process modeled by the user.

Security of personal information has become an increasing concern of governments and regulatory bodies throughout the world during the 21^{st} century. As an example, the European Union (EU) has recently enacted the General Data Protection Regulation (GDPR), which dictates requirements for processing of personal data of EU individuals, regardless of the geographical location of such processing. In short, enterprises doing business within the EU may be required to adhere to the GDPR, or face stiff fines or penalties. The GDPR contains several provisions requiring controllers of personal data (e.g., enterprises engaged in data integration processes) to place an appropriate technical and organization measures to implement data protection principles. Further, upon request of an EU citizen whose personal data has been included within an integration process, an adherent to the GDPR (e.g., entity performing data integration processes) must provide adequate explanation of the ways in which such personal data has been manipulated or transferred.

One way for an enterprise system executing data integration processes to protect against infringement involves tracking the content of data model field values being integrated, and the ways in which such data is being manipulated. For example, an ability to identify sensitive information and apply added security measures to integration processes involving such sensitive information may lessen the risk of infringement. In embodiments described herein, a data integration protection assistance system may search code instructions for one or more integration processes to identify data model field values accessed, copied, transferred, or otherwise manipulated therein that may contain sensitive information. Upon identification of a data model field value meeting preset search terms designed to identify sensitive information, the data integration protection assistance system in embodiments may label the identified data model field value as sensitive using one or more of a plurality of labels. For example, sensitive information in some embodiments may receive a label identifying a data model field value as falling within one of a plurality of types of sensitive information, including personal data, sensitive data, security data, health data, financial data, or national data. Individual data records within data model field values may be labeled as one of these categories based on a description stored in metadata (e.g., documents marked confidential), or within the data model fieldname for the data (e.g., data model field value having a data model fieldname that includes search terms such as “FirstName,” or “SSN” for Social Security Number). Thus, by searching code instructions including data model fieldnames and metadata of data model field values accessed, copied, transferred, or otherwise manipulated throughout an integration process, the data integration protection assistance system in embodiments may assist enterprises in determining where added security measures may be needed.

Similar methods may also assist in deterring or lessening potential fines if an infringement should occur. Failure to comply with the GDPR may result in hefty fines. The level of fine levied against a non-compliant entity is determined according to a variety of factors, that include the extent of the infringement (e.g., number of people affected and damage caused thereto), mitigating acts taken by the non-compliant entity following infringement, preventative measures taken by the non-compliant entity prior to the infringement, what types of data were impacted by the infringement, and whether the non-compliant entity promptly notified those who were affected by the infringement, among others. In the unfortunate event of an infringement, enterprises executing data integration processes may at least decrease the amount of the resultant penalties by providing detailed metrics describing data affected by each integration process, individuals whose information was incorporated within such data, and the ways in which such data was accessed, copied, transferred, or otherwise manipulated in an infringing integration process. Such detailed information may indicate preventative and mitigating measures were taken, and may assist in notification of individuals impacted. Further, providing a tangible number of individuals impacted may avoid an assumption of a much higher number of victims and damages caused thereto.

In addition to labeling a data model field value as falling within one of the preset sensitive categories described above, the data integration protection assistance system in embodiments described herein may also track the movement of such a data model field value throughout the integration process, to assist with the type or reporting required by the GDPR. As described herein, because multiple steps within the integration process may be executed using different coding languages, the code instructions for retrieving a given data model field value from a first application/location/enterprise may describe that data model field value using a completely different data model fieldname than the code instructions for transmitting the same data model field value to a second application/location/enterprise. Thus, even after a data model field value is identified at a given step of such an integration process as “sensitive,” a method is needed to map the movement that data model field value through each application/location/enterprise involved in the process, and to mark the other data model fieldnames associated with this data model field value throughout the rest of the integration process as “sensitive,” even if these other data model fieldnames did not match the search terms used to identify the first data model fieldname as “sensitive.”

The data integration protection assistance system in embodiments described herein may address this issue by mapping each data model fieldname given to a given data model field value throughout an integration process, identifying which of these data model fieldnames was applied at each application/location/enterprise involved in the integration process, and the manipulation or action performed by each of these applications/locations/enterprises during the integration process. Users of the visual user interface describing the flow of the integration process in embodiments described herein may use map elements to associate a first data model fieldname for a data model field value being retrieved from a first application or source with a second data model fieldname under which that data model field value will be stored at a second application or destination. Because a single integration process may transmit data model field values between or among several sources and destinations, a process flow may include several of these mapping elements, sometimes placed in series with one another. This may result in a single data model field value receiving several different data model fieldnames as it moves from various sources to various destinations throughout the integration process.

In embodiments described herein, the data integration protection assistance system may draw on information supplied via these mapping elements to generate and display a fieldname lineage map that illustrates, in chronological order with respect to the integration process, the ways in which the data model fieldname used to describe a single data model field value changes throughout that process. Once such a fieldname lineage map has been created, the data integration protection assistance system in embodiments may identify all data model fieldnames that have been used to describe a data model field value previously labeled as containing sensitive information, and further apply that label to each of the data model fieldnames associated with that data model fieldname in the fieldname lineage map, even if those other data model fieldnames did not meet the original search criteria entered by the user.

Fieldname lineage maps generated in such a fashion may also streamline future searches across data model fieldnames. No uniform or standard applies to the ways in which a user may define data model fieldnames. In some circumstances, naming conventions provide contextual indicators of the contents of the data model field values associated with the data model fieldname. For example, some applications may associate a data model field value that includes a social security number with a data model fieldname “Social_Security_Number.” However, in other circumstances, the data model fieldname associated with a data model field value provides little, no, or confusing contextual indicators of the content of that data model field value. For example, the data model field value described above having the data model fieldname “Social_Security_Number” when retrieved from a first application may be stored at a second application or location under the data model fieldname “Title.” A user attempting to label data model field values that may contain social security numbers may be likely to use a search term such as “social,” but would be unlikely to search for social security numbers using the search term “title.” A method is needed to streamline a user's ability to search across data model fieldnames that do not provide contextual indicators of data model field value content using search contextual search terms.

The data integration protection assistance system in embodiments described herein addresses this issue by identifying data model fieldnames that do not provide contextual indicators, and thus are not likely to meet contextual search terms, but are paired with data model field values having content described by the search term. The data integration protection assistance system may perform such an identification by referencing the above described fieldname lineage maps. Such maps may link a data model fieldname that includes a user-specified contextual search term with a plurality of other data model fieldnames (applied to the same data model field value as the data model fieldname that meets the search term) that do not meet include the contextual search term. The data integration protection assistance system may store an association between the user-specified search term, the data model fieldname that met that search term, and each of the plurality of data model fieldnames linked to the data model fieldname that met that search term via the fieldname lineage map in embodiments described herein. Upon later user instruction to search the same term, the data integration protection assistance system in embodiments described herein may automatically search that term, as well as each of the data model fieldnames linked to the data model fieldname that meets this search term within the fieldname lineage map. In such a way, the data integration protection assistance system may overcome the problem of non-contextual naming conventions.

In embodiments described herein, the data integration protection assistance system may further display such information, in a searchable format, for easy generation of reports complying with GDPR requirements. For example, the data integration protection assistance system in embodiments may employ a visual user interface to display descriptive information for one or more data model field values labeled as “sensitive.” Such a visual display may allow a user to view all data model field values labeled under any of the sensitive categories described herein occurring within a single integration process, or across a plurality of integration processes. Users may also display descriptive information of sensitive data model field values by specific data model fieldname of the data model field value, the specific label applied to the data model field value (e.g., personal, financial, health, security, national, sensitive), or the physical location of the servers that received or temporarily stored such data model field values during the integration process. The data integration protection assistance system may also allow users to display descriptive information about such data model field values according to the shape of the visual connector associated with the code set in which the data model field value was identified as sensitive, the name of the application or enterprise executing that code set, or the way in which such a code set operated to manipulate that data model field value. Once the user locates a data model field value of interest using such a visual user interface in embodiments described herein, the data integration protection assistance system may export the code instructions in which the data model field value was identified, in one of a plurality of different code languages, as selected by the user, via the visual user interface. In such a way, the data integration protection assistance system in embodiments described herein may track which data model field values containing personal information were accessed, transferred, or otherwise manipulated during an integration process and how, as well as the applications/locations/enterprises at which such access or manipulation occurred.

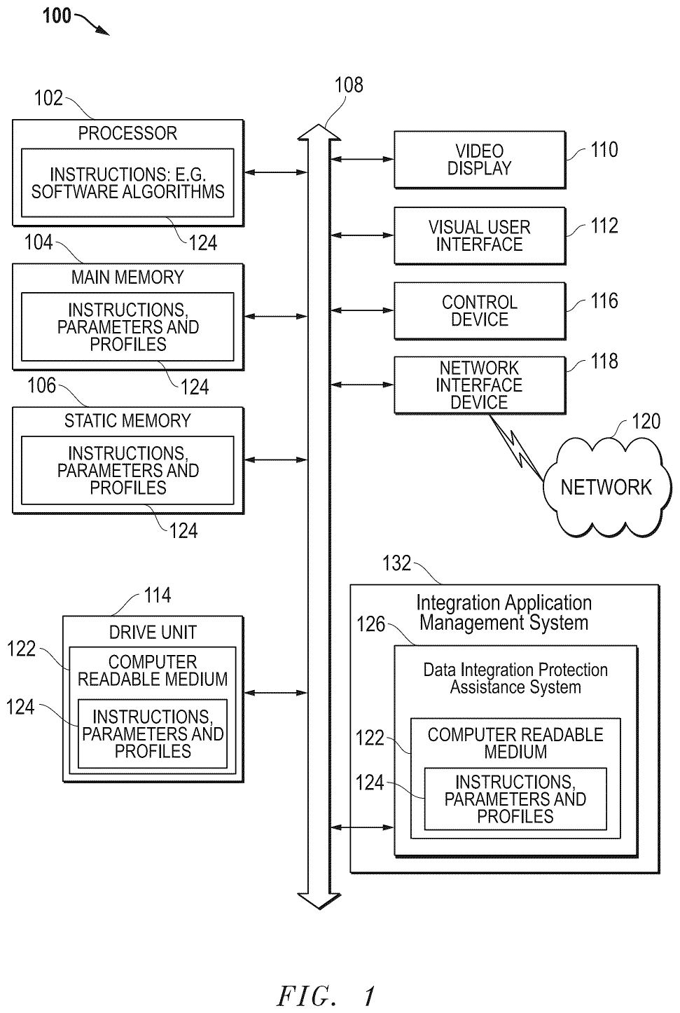

FIG. 1 is a block diagram illustrating an information handling system, according to an embodiment of the present disclosure. Information handling system 100 can include processing resources for executing machine-executable code, such as a central processing unit (CPU), a programmable logic array (PLA), an embedded device such as a System-on-a-Chip (SoC), or other control logic hardware used in an information handling system several examples of which are described herein. Information handling system 100 can also include one or more computer-readable media for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

FIG. 1 illustrates an information handling system 100 similar to information handling systems according to several aspects of the present disclosure. For example, an information handling system 100 may be any mobile or other computing device capable of executing a set of instructions (sequential or otherwise) that specify actions to be taken by that machine. In a particular embodiment, the information handling system 100 can be implemented using electronic devices that provide voice, video, or data communication. Further, while a single information handling system 100 is illustrated, the term “system” shall also be taken to include any collection of systems or sub-systems that individually or jointly execute a set, or multiple sets, of instructions to perform one or more computer functions.

Information handling system 100 can include devices or modules that embody one or more of the devices or execute instructions for the one or more systems and modules herein, and operates to perform one or more of the methods. The information handling system 100 may execute code 124 for the data integration protection assistance system 126, or the integration application management system 132 that may operate on servers or systems, remote data centers, or on-box in individual client information handling systems such as a local display device, or a remote display device, according to various embodiments herein. In some embodiments, it is understood any or all portions of code 124 for the data integration protection assistance system 126 or the integration application management system 132 may operate on a plurality of information handling systems 100.

The information handling system 100 may include a processor 102 such as a central processing unit (CPU), a graphics-processing unit (GPU), control logic or some combination of the same. Any of the processing resources may operate to execute code that is either firmware or software code. Moreover, the information handling system 100 can include memory such as main memory 104, static memory 106, drive unit 114, or the computer readable medium 122 of the data integration protection assistance system 126, or the integration application management system 132 (volatile (e.g. random-access memory, etc.), nonvolatile (read-only memory, flash memory etc.) or any combination thereof). Additional components of the information handling system can include one or more storage devices such as static memory 106, drive unit 114, and the computer readable medium 122 of the data integration protection assistance system 126, or the integration application management system 132. The information handling system 100 can also include one or more buses 108 operable to transmit communications between the various hardware components such as any combination of various input and output (I/O) devices. Portions of an information handling system may themselves be considered information handling systems.

As shown, the information handling system 100 may further include a video display 110, such as a liquid crystal display (LCD), an organic light emitting diode (OLED), a flat panel display, a solid state display, or other display device. Additionally, the information handling system 100 may include a control device 116, such as an alpha numeric control device, a keyboard, a mouse, touchpad, fingerprint scanner, retinal scanner, face recognition device, voice recognition device, or gesture or touch screen input.

The information handling system 100 may further include a visual user interface 112. The visual user interface 112 in an embodiment may provide a visual designer environment permitting a user to define process flows between applications/systems, such as between trading partner and enterprise systems, and to model a customized business integration process. The visual user interface 112 in an embodiment may provide a menu of pre-defined user-selectable visual elements and permit the user to arrange them as appropriate to model a process and may be displayed on the video display 110. The elements may include visual, drag-and-drop icons representing specific units of work required as part of the integration process, such as invoking an application-specific connector, transforming data from one format to another, routing data down multiple paths of execution by examining the contents of the data, business logic validation of the data being processed, etc.

Further, the graphical user interface 112 allows the user to provide user input providing information relating to trading partners, activities, enterprise applications, enterprise system attributes, and/or process attributes that are unique to a specific enterprise end-to-end business integration process. For example, the graphical user interface 112 may provide drop down or other user-selectable menu options for identifying trading partners, application connector and process attributes/parameters/settings, etc., and dialog boxes permitting textual entries by the user, such as to describe the format and layout of a particular data set to be sent or received, for example, a Purchase Order. The providing of this input by the user results in the system's receipt of such user-provided information as an integration process data profile code set.

In some embodiments, the graphical user interface 112 may also allow a user to provide one or more search terms that may be used to identify data model field values affected by one or more integration processes that are likely to include sensitive information. A user in such an embodiment may interact with such a user interface 112 to include or exclude terms used by the data integration protection assistance system 124 to search code instructions executed during one or more integration processes for potentially sensitive data model field values manipulated therein. In yet another embodiment, a user may employ the graphical user interface 112 to search and view information describing data model field values identified in such a manner as potentially sensitive.

The information handling system 100 can represent a server device whose resources can be shared by multiple client devices, or it can represent an individual client device, such as a desktop personal computer, a laptop computer, a tablet computer, or a mobile phone. In a networked deployment, the information handling system 100 may operate in the capacity of a server or as a client user computer in a server-client user network environment, or as a peer computer system in a peer-to-peer (or distributed) network environment.

The information handling system 100 can include a set of instructions 124 that can be executed to cause the computer system to perform any one or more of the methods or computer based functions disclosed herein. For example, information handling system 100 includes one or more application programs 124, and Basic Input/Output System and Firmware (BIOS/FW) code 124. BIOS/FW code 124 functions to initialize information handling system 100 on power up, to launch an operating system, and to manage input and output interactions between the operating system and the other elements of information handling system 100. In a particular embodiment, BIOS/FW code 124 reside in memory 104, and include machine-executable code that is executed by processor 102 to perform various functions of information handling system 100. In another embodiment (not illustrated), application programs and BIOS/FW code reside in another storage medium of information handling system 100. For example, application programs and BIOS/FW code can reside in static memory 106, drive 114, in a ROM (not illustrated) associated with information handling system 100 or other memory. Other options include application programs and BIOS/FW code sourced from remote locations, for example via a hypervisor or other system, that may be associated with various devices of information handling system 100 partially in memory 104, storage system 106, drive unit 114 or in a storage system (not illustrated) associated with network interface device 118 or any combination thereof. Application programs 124, and BIOS/FW code 124 can each be implemented as single programs, or as separate programs carrying out the various features as described herein. Application program interfaces (APIs) such as WinAPIs (e.g. Win32, Win32s, Win64, and WinCE), or an API adhering to a known open source specification may enable application programs 124 to interact or integrate operations with one another.

In an example of the present disclosure, instructions 124 may execute software for identifying, labeling, tracking, and reporting information describing data model field values accessed, transferred, copied, or otherwise manipulated during an integration process, for compliance with governmental regulations. The computer system 100 may operate as a standalone device or may be connected, such as via a network, to other computer systems or peripheral devices.

Main memory 104 may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The disk drive unit 114, the integration application management system 132, and the data integration protection assistance system 126 may include a computer-readable medium 122 such as a magnetic disk, or a solid-state disk in an example embodiment. The computer-readable medium of the memory, storage devices and the data integration protection assistance system 104, 106, 114, 132 and 126 may store one or more sets of instructions 124, such as software code corresponding to the present disclosure.

The disk drive unit 114, static memory 106, and computer readable medium 122 of the data integration protection assistance system 126, or the integration application management system 132 also contain space for data storage such as an information handling system for managing locations of executions of customized integration processes in endpoint storage locations. Connector code sets, and trading partner code sets may also be stored in part in the disk drive unit 114, static memory 106, or computer readable medium 122 of the data integration protection assistance system 126, or the integration application management system 132 in an embodiment. In other embodiments, data profile code sets, and run-time engines may also be stored in part or in full in the disk drive unit 114, static memory 106, or computer readable medium 122 of the data integration protection assistance system 126, or the integration application management system 132. Further, the instructions 124 of the data integration protection assistance system 126, or the integration application management system 132 may embody one or more of the methods or logic as described herein.

In a particular embodiment, the instructions, parameters, and profiles 124, and the data integration protection assistance system 126, or the integration application management system 132 may reside completely, or at least partially, within the main memory 104, the static memory 106, disk drive 114, and/or within the processor 102 during execution by the information handling system 100. Software applications may be stored in static memory 106, disk drive 114, and the data integration protection assistance system 126, or the integration application management system 132.

Network interface device 118 represents a NIC disposed within information handling system 100, on a main circuit board of the information handling system, integrated onto another component such as processor 102, in another suitable location, or a combination thereof. The network interface device 118 can include another information handling system, a data storage system, another network, a grid management system, another suitable resource, or a combination thereof.

The data integration protection assistance system 126 and the integration application management system 132 may also contain computer readable medium 122. While the computer-readable medium 122 is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The information handling system 100 may also include the data integration protection assistance system 126, and the integration application management system 132. The Data integration protection assistance system 126, and the integration application management system 132 may be operably connected to the bus 108. The data integration protection assistance system 126 and the integration application management system 132 are discussed in greater detail herein below.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, or module can include software, including firmware embedded at a device, such as an Intel® Core class processor, ARM® brand processors, Qualcomm® Snapdragon processors, or other processors and chipset, or other such device, or software capable of operating a relevant environment of the information handling system. The system, device or module can also include a combination of the foregoing examples of hardware or software. In an example embodiment, the Data integration protection assistance system 126, and the integration application management system 132 above and the several modules described in the present disclosure may be embodied as hardware, software, firmware or some combination of the same. Note that an information handling system can include an integrated circuit or a board-level product having portions thereof that can also be any combination of hardware and software. Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

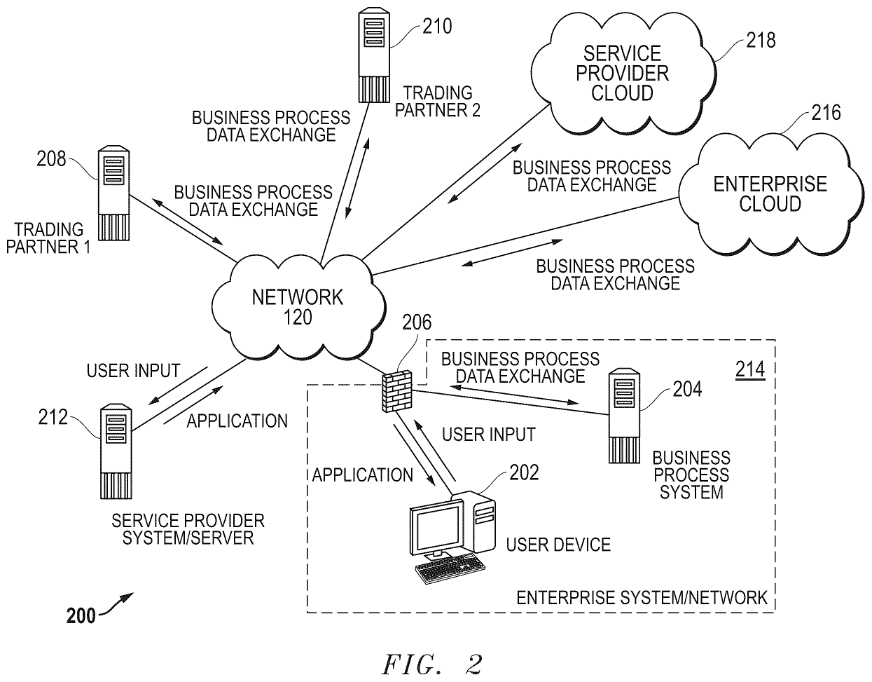

FIG. 2 is a graphical diagram illustrating a simplified integration network 200 including a service provider system/server 212 and an enterprise system/network 214 in an embodiment according to the present disclosure. Actual integration network topology could be more complex in some other embodiments. As shown in FIG. 2, an embodiment may include conventional computing hardware of a type typically found in client/server computing environments. More specifically, the integration network 200 in an embodiment may include a conventional user/client device 202, such as a conventional desktop or laptop PC, enabling a user to communicate via the network 120, such as the Internet. In another aspect of an embodiment, the user device 202 may include a portable computing device, such as a computing tablet, or a smart phone. The user device 202 in an embodiment may be configured with conventional web browser software, such as Google Chrome®, Firefox®, or Microsoft Corporation's Internet Explorer® for interacting with websites via the network 120. In an embodiment, the user device 202 may be positioned within an enterprise network 214 behind the enterprise network's firewall 206, which may be of a conventional type. As a further aspect of an embodiment, the enterprise network 214 may include a business process system 204, which may include conventional computer hardware and commercially available business process software such as QuickBooks, SalesForce's™ Customer Relationship Management (CRM) Platform, Oracle's™ Netsuite Enterprise Resource Planning (ERP) Platform, Infor's™ Warehouse Management Software (WMS) Application, or many other types of databases.

In an embodiment, the integration network 200 may further include trading partners 208 and 210 operating conventional hardware and software for receiving and/or transmitting data relating to business-to-business transactions. For example, Walmart® may operate trading partner system 208 to allow for issuance of purchase orders to suppliers, such as the enterprise 214, and to receive invoices from suppliers, such as the enterprise 214, in electronic data form as part of electronic data exchange processes. Electronic data exchange process in an embodiment may include data exchange via the world wide web. In other embodiments, electronic data exchange processes may include data exchange via FTP or SFTP.

In an embodiment, a provider of a service (“service provider”) for creating on-demand, real-time creation of customized data integration software applications may operate a service provider server/system 212 within the integration network 200. The service provider system/server 212 may be specially configured in an embodiment, and may be capable of communicating with devices in the enterprise network 214. The service provider system/server 212 in an embodiment may host an integration process-modeling user interface in an embodiment. Such an integration process-modeling user interface may allow a user or the data integration protection assistance system to model an integration process including one or more sub-processes for data integration through a business process data exchange between an enterprise system/network 214 and outside entities or between multiple applications operating at the business process system 204. The integration process modeled in the integration process-modeling user interface in an embodiment may be a single business process data exchange shown in FIG. 2, or may include several business process data exchanges shown in FIG. 2. For example, the enterprise system/network 214 may be involved in a business process data exchange via network 120 with a trading partner 1, and/or a trading partner 2. In other example embodiments, the enterprise system/network 214 may be involved in a business process data exchange via network 120 with a service provider located in the cloud 218, and/or an enterprise cloud location 216. For example, one or more applications between which a data model field value may be transferred, according to embodiments described herein, may be located remotely from the enterprise system 214, at a service provider cloud location 218, or an enterprise cloud location 216.

The data integration protection assistance system, or a user of an integration process-modeling user interface in an embodiment may model one or more business process data exchanges via network 120 within an integration process by adding one or more connector integration elements or code sets to an integration process flow. These connector integration elements in an embodiment may model the ways in which a user wishes data to be accessed, moved, and/or manipulated during the one or more business process data exchanges. Each connector element the data integration protection assistance system or the user adds to the integration process flow diagram in an embodiment may be associated with a pre-defined subset of code instructions stored at the service provider systems/server 212 in an embodiment. Upon the user modeling the integration process, the service provide system/server 212 in an embodiment may generate a run-time engine capable of executing the pre-defined subsets of code instructions represented by the connector integration elements chosen by the user or indicated by the data integration protection assistance system. The runtime engine may then execute the subsets of code instructions in the order defined by the modeled flow of the connector integration elements given in the integration process flow diagram. In some embodiments, the data integration protection assistance system may define the order in which such subsets of code instructions are executed by the runtime engine without creation of or reference to a visual integration process flow diagram. In such a way, an integration process may be executed without the user having to access, read, or write the code instructions of such an integration process.

In other aspects of an embodiment, a user may initiate a business process data exchange between one cloud service provider 218 and one cloud enterprise 216, between multiple cloud service providers 218 with which the enterprise system 214 has an account, or between multiple cloud enterprise accounts 216. For example, enterprise system 214 may have an account with multiple cloud-based service providers 218, including a cloud-based SalesForce™ CRM account and a cloud-based Oracle™ Netsuite account. In such an embodiment, the enterprise system 214 may initiate business process data exchanges between itself, the SalesForce™ CRM service provider and the Oracle™ Netsuite service provider.

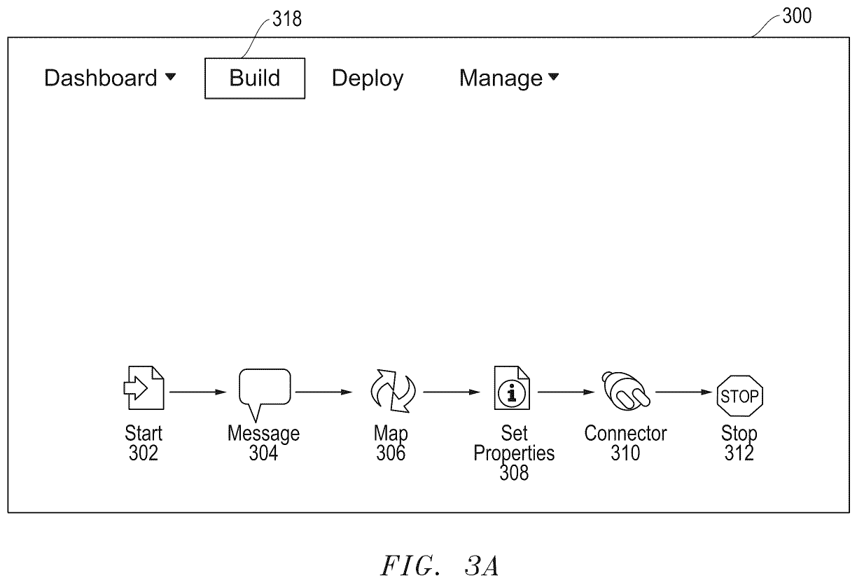

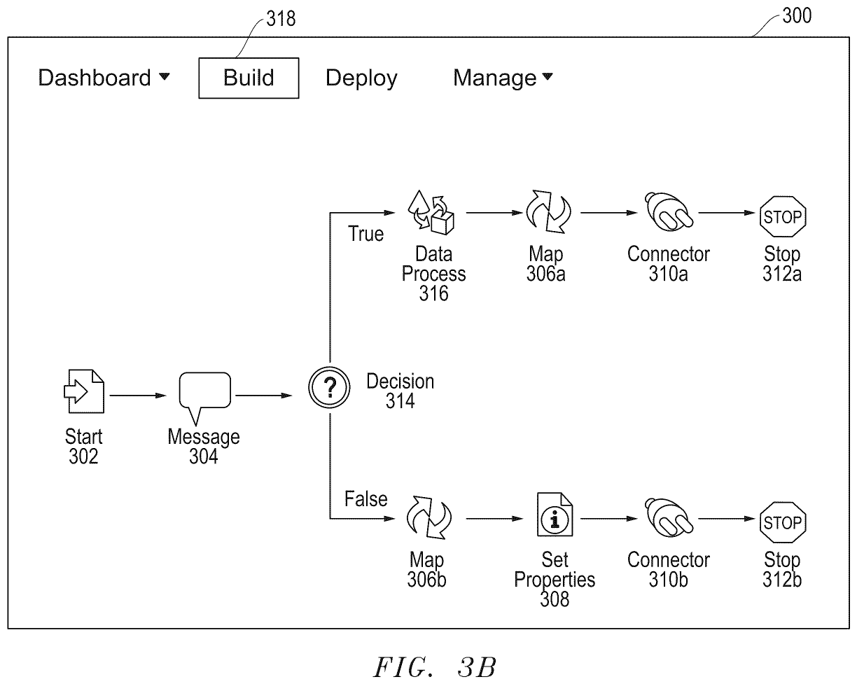

FIG. 3A is a graphical diagram illustrating a user-generated flow diagram of an integration process for exchange of electronic data records according to an embodiment of the present disclosure. The flow diagram in an embodiment may be displayed within a portion of a graphical user interface 300 that allows the user to build the process flow, deploy the integration process modeled thereby, manage data model field values manipulated by such an integration process, and to view high-level metrics associated with execution of such an integration process. The user may build the process flow and view previously built process flow diagrams by selecting the “Build” tab 318 in an embodiment. A user may generate a flow diagram in an embodiment by providing a chronology of process-representing integration elements via the use of an integration process-modeling user interface. In some embodiments, the integration process-modeling user interface may take the form of a visual user interface. In such embodiments, the user-selectable elements representing integration sub-processes (e.g. connector integration elements) may be visual icons.

An integration process-modeling user interface in an embodiment may provide a design environment permitting a user to define process flows between applications/systems, such as between trading partner and enterprise systems, between on-site data centers and cloud-based storage modules, or between multiple applications, and to model a customized business integration process. Such an integration process-modeling user interface in an embodiment may provide a menu of pre-defined user-selectable elements representing integration sub-processes and permit the user or the data integration protection assistance system to arrange them as appropriate to model a full integration process. For example, in an embodiment in which the integration process-modeling user interface is a visual user interface, the elements may include visual, drag-and-drop icons representing specific units of work (known as process components) required as part of the integration process. Such a process components in an embodiment may include invoking an application-specific connector to access, and/or manipulate data. In other embodiments, process components may include tasks relating to transforming data from one format to another, routing data down multiple paths of execution by examining the contents of the data, business logic validation of the data being processed, etc.

Each process component as represented by integration sub-process icons or elements may be identifiable by a process component type, and may further include an action to be taken. For example, a process component may be identified as a “connector” component. Each “connector” component, when chosen and added to the process flow in the integration process-modeling user interface, may allow the data integration protection assistance system or a user to choose from different actions the “connector” component may be capable of taking on the data as it enters that process step. Further the integration-process modeling user interface in an embodiment may allow the user to choose the data set or data element upon which the action will be taken. The action and data element the user chooses may be associated with a connector code set, via the integration application management system, which may be pre-defined and stored at a system provider's memory in an embodiment. The integration application management system operating at least partially at a system provider server/system in an embodiment may generate a dynamic runtime engine for executing these pre-defined subsets of code instructions correlated to each individual process-representing visual element (process component) in a given flow diagram in the order in which they are modeled in the given flow diagram, or by the data integration protection assistance system in a non-visual format.

In an embodiment, a user may choose a process component it uses often when interfacing with a specific trade partner or application, and define the parameters of that process component by providing parameter values specific to that trading partner or application. If the user wishes to use this process component, tailored for use with that specific trading partner or application repeatedly, the user may save that tailored process component as a trading partner or component named specifically for that application. For example, if the user often accesses NetSuite™ or SalesForce™, the user may create a database connector process component, associated with a pre-built connector code set that may be used with any database, then tailor the database connector process component to specifically access NetSuite™ or SalesForce™ by adding process component parameters associated with one of these applications. If the user uses this process component in several different integration processes, the user may wish to save this process component for later use by saving it as a NetSuite™ or SalesForce™ process component. In the future, if the user wishes to use this component, the user may simply select the NetSuite™ or SalesForce™ component, rather than repeating the process of tailoring a generic database connector process component with the specific parameters defined above.

As shown in FIG. 3A, such process-representing visual elements may include a start element 302, a message element 304, a map element 306, a set properties element 308, a connector element 310, and a stop element 312. Other embodiments may also include a branch element, a decision element, a data process element, or a process call element, for example. A connector element 310, and a start element 302 in an embodiment may represent a sub-process of an integration process describing the accessing and/or manipulation of data. The start element 302 in an embodiment may also operate as a connector element.

In an embodiment, a start element 302 may operate to begin a process flow, and a stop element 312 may operate to end a process flow. As discussed above, each visual element may require user input in order for a particular enterprise or trading partner to use the resulting process. The start element 302 in an embodiment may further allow or require the user to provide data attributes unique to the user's specific integration process, such as, for example, the source of incoming data to be integrated. For example, the user or the data integration protection assistance system may use a connector element to define a connection (e.g., an application managing data upon which action is to be taken), and the action to be taken. A user may use a connector element to further define a location of such data, according to the language and storage structure understood by the application managing such data. In addition, the data to be accessed according to such a start element 302 may be identified by a data model fieldname given in a format that adheres to the code language and storage structure used by the application/location/enterprise at which such a data model field value may be accessed.

A map element 306, or TransformMap element in an embodiment may associate a first data model fieldname for a data model field value being retrieved from a first application or source with a second data model fieldname under which that data model field value will be stored at a second application or destination. A user may also provide an operation name that describes the purpose for changing the data model fieldnames of the data model field value in such a way. Because a single integration process may transmit data model field values between or among several sources and destinations, a process flow may include several of these mapping elements 306, sometimes placed in series with one another. This may result in a single data model field value receiving several different data model fieldnames as it moves from various sources to various destinations throughout the integration process.

A set properties element 308 in an embodiment may allow the user to set values identifying specific files. Set properties elements in an embodiment may associate a user-defined property with a user-defined parameter, similar to a key-value pair definition. For example, a user or the data integration protection assistance system in an embodiment may use a set properties element to set the property “data model fieldname” to a parameter “Shipping Address,” in order to identify a specific data model field value entitled “Shipping Address.” In some embodiments, this may invoke a call to an API controlling access to the application/location/enterprise managing such a data model field value to search for a data model field value having a data model fieldname that matches one or more of these descriptive phrases, rather than identifying a data model field value having the exact data model fieldname “Shipping Address.” For example, a user entering the value “Shipping Address” in an embodiment may invoke a call to locate data model field values having data model fieldnames “Shipping_Address,” “shipping_address,” “ShippingAddress,” “SAddress,” etc.

The code sets associated with such property and parameter fields in an embodiment may be written in any programming code language, so long as the code language in which the property is defined matches the code language in which the parameter is also defined. Similarly, the code sets associated with the connection location and action to be taken within a connector element may be written in any programming code language so long as they are consistent with one another. Thus, the process-representing elements in an embodiment may be programming language-agnostic. Using such process-representing elements in an embodiment, a user may model an end-to-end integration process between multiple applications that each use different naming conventions and storage structures for storage of data model field values. As a result, a single data model field value accessed at the start element 302 and transmitted to a second location at the connector element 310 in an embodiment may be identified at the start element 302 with a completely different data model fieldname (e.g., “Social_Security_Number”) than the data model fieldname (e.g., “Title”) used to identify the exact same data model field value at the connector element 310.

If a user anticipates a modeled integration process may access, copy, transmit, or otherwise manipulate a data model field value likely to include sensitive information (e.g., personal information protected under the GDPR), the user may provide terms describing such data within a message element 304 in an embodiment. For example, a user may add a message element 304 to the visual flow process within the user interface, which may then prompt the user to provide one or more search terms the data integration protection assistance system may use to identify potentially sensitive information, as described in greater detail herein. The data integration protection assistance system in embodiments described herein may operate to identify, label, and track the ways in which such given data model field value information is handled throughout the integration process modeled by the user, despite the plurality of data model fieldnames used to identify such information throughout the process.

FIG. 3B is a graphical diagram illustrating a user-generated flow diagram of an integration process providing added security for exchange of electronic data records containing personal information according to an embodiment of the present disclosure. As described herein, the GDPR contains several provisions requiring controllers of personal data (e.g., enterprises engaged in data integration processes) to place an appropriate technical and organization measures to implement data protection principles. The data integration protection assistance system in an embodiment may operate to identify sensitive information and apply added security measures to integration processes involving such sensitive information, to avoid the risk of infringing the GDPR.

In embodiments described herein, a data integration protection assistance system may search code instructions for one or more integration processes to identify data model field values accessed, copied, transferred, or otherwise manipulated therein that may contain sensitive information. Upon identification of a data model field value meeting preset search terms provided by the user within the message element 304 and designed to identify sensitive information, the data integration protection assistance system in embodiments may label the identified data model field value as sensitive using one or more of a plurality of labels. The data integration protection assistance system in an embodiment may then apply greater security measures to data model field values identified in such a way as sensitive.

For example, the data integration protection assistance system in an embodiment may automatically adjust the integration process modeled by the user via the user interface, as described with reference to FIG. 3A, by adding an encryption layer to all data model field values identified as potentially sensitive. As described herein, a user may view and edit previously built process flow diagrams by selecting the “Build” tab 318 within the graphical user interface 300 in an embodiment. As shown in FIG. 3B, the data integration protection assistance system may insert a decision element 314 immediately following the message element 304. The decision element 314 in such an embodiment may route incoming data model field values based on whether they meet a preset criterion. For example, the data integration protection assistance system in an embodiment may associate the decision element 314 with a statement, such as, “the incoming data model field value meets one or more of the search criteria provided by the user within the message element 304.” If such an assigned statement proves true (e.g., the incoming data model field value meets the search terms for sensitive information), this may indicate the incoming data model field value may contain personal identification information, and the decision element 314 may route the integration process including that data model field value toward data process element 316, which may operate to apply added security, such as an encryption algorithm to the integration process. If such an assigned statement proves false, this may indicate the incoming data model field value likely does not contain personal identification information, and the decision element 314 may route the integration process toward the map element 306.

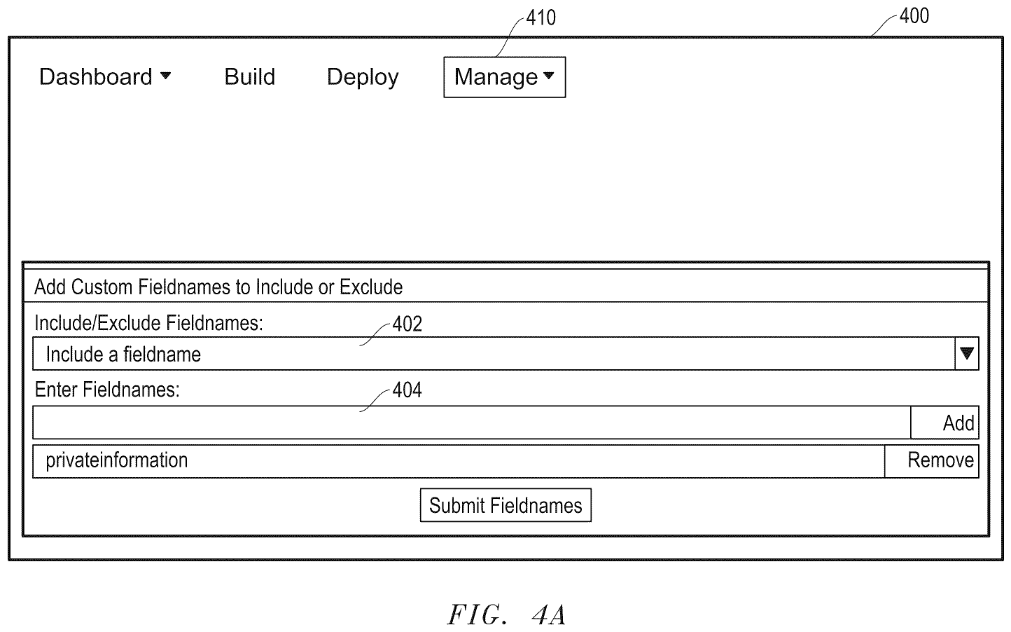

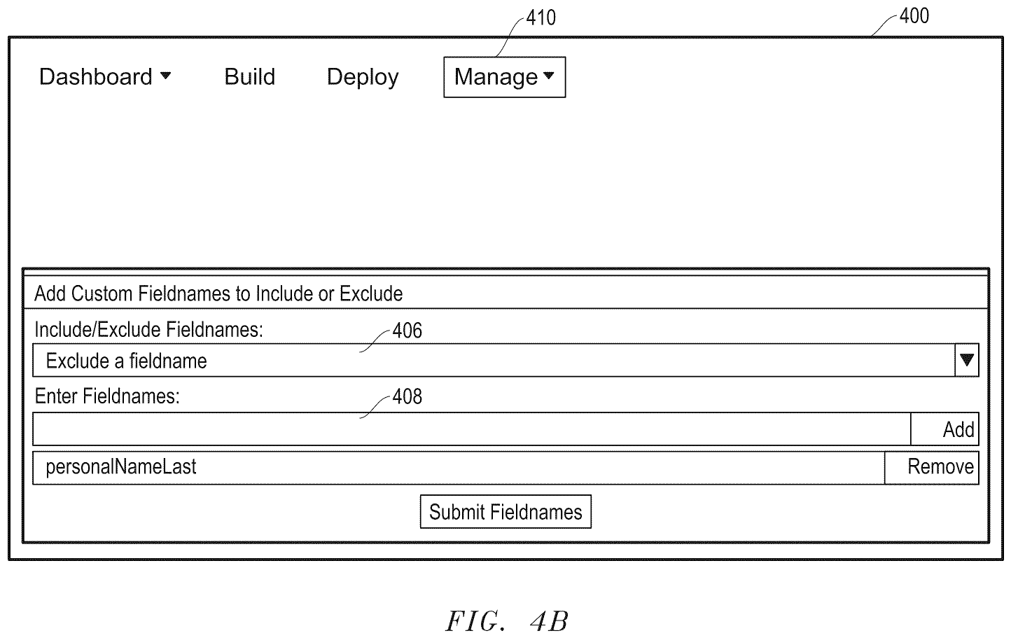

FIG. 4A is a graphical diagram illustrating a user interface for entering terms describing data model fieldnames associated with data model field values likely to contain potentially sensitive information for use in labeling such data model field values as potentially sensitive according to an embodiment of the present disclosure. As described herein, one way for an enterprise system executing data integration processes to comply with the GDPR's individual data protection provisions involves tracking the content of data model field values being integrated, and the ways in which such data is being manipulated. For example, an ability to identify sensitive information and apply added security measures to integration processes involving such sensitive information may lessen the risk of infringement. In order to assist in adherence to these GDPR regulations, the data integration protection assistance system may search code instructions for one or more integration processes to identify data model field values accessed, copied, transferred, or otherwise manipulated therein that may contain sensitive information. By searching code instructions including data model fieldnames and metadata of data model field values accessed, copied, transferred, or otherwise manipulated throughout an integration process for certain user-specified key words or search terms, the data integration protection assistance system in embodiments may assist enterprises in determining where added security measures may be needed.

As also described herein, a single integration process may involve executing code instructions in a plurality of coding languages at a plurality of applications, locations, or enterprises, each using different ways of describing data model field values, object classes, variables, or storage locations. Thus, the code instructions for retrieving a given data model field value from a first application may describe that data model field value using a completely different data model fieldname than the code instructions for transmitting the same data model field value to a second application. In fact, a single data model field value may be described in a single integration process using several different data model fieldnames, each adhering to the naming conventions set by the multiple applications, enterprises, or trading partners through or among which the data model field value is programmed to integrate. These changes to the data model fieldnames for data model field values in an embodiment present a challenge for identifying which of these data model field values contains personal information. For example, it may be relatively easy to identify a data model field value having a data model fieldname “FirstName” as including the name of an individual, but much more difficult to identify a data model field value transmitted and stored at another location with a data model fieldname “FN” as personal information, even if these data model fieldnames describe the exact same data model field value.

The data integration protection assistance system in an embodiment may overcome this complication by searching across all code instructions of an integration process and metadata associated with data model field values being integrated pursuant thereto to identify potentially sensitive information. In order to perform such a thorough search, the data integration protection assistance system in an embodiment may receive one or more user-defined search terms the user believes may be used within a data model fieldname or metadata associated with a data model field value that is likely to contain sensitive personal information. For example, the user may provide one or more such search terms using the search term user interface 400 illustrated in FIG. 4A, which may correspond to the graphical user interface 300 described above with reference to FIG. 3A, that allows the user to build the process flow, deploy the integration process modeled thereby, manage data model field values manipulated by such an integration process, and to view high-level metrics associated with execution of such an integration process. The user may provide one or more search terms by selecting the “Manage” tab 410 in an embodiment.

The search term user interface 400 may allow the user to provide a search term 404 likely to be found in a data model fieldname of a data model field value within a given integration process. In some embodiments, the data integration protection assistance system may prompt the user to provide such information by displaying the search term user interface 400 under certain circumstances. For example, the search term user interface 400 may be displayed for user interaction upon the user inserting a message element into a process flow indicating the integration process modeled by that flow may apply to sensitive personal information.

The user may enter one or more search terms 404 likely to be identified within the data model fieldnames of such data model field values, and may use the field 402 to include those terms within a search for potentially sensitive personal information. For example, the user may enter within field 404 a search term “Shipping Address” to identify one or more data model field values integrated between an accounting application tracking customer billing and a shipping application tracking customer deliveries. In such an integration process, such a data model field value may contain sensitive personal information, such as the address of a customer. Upon selection by the user at field 402 to include a search term “Shipping Address” entered at field 404 in such an embodiment, the data integration protection assistance system may search data model fieldnames for all data model field values identified in each code set underlying the integration process. If a data model fieldname for any data model field value identified in these underlying code sets includes one or more of these search terms in an embodiment, the data integration protection assistance system may label that data model field value as including sensitive personal information.

In some embodiments, the user may further associate search terms provided at field 404 with one or more specific categories of personal information. For example, a data model field value may include several different types of sensitive personal information. In an example embodiment, the data integration protection assistance system or a user may define one or more of such different categories of sensitive personal information. For example, in some embodiments, sensitive personal information may fall within one or more of a plurality of categories including personal information, health information, financial information, security information, national information, or sensitive.

Each of these categories may describe different types of sensitive information, and may be associated with separate search terms supplied at field 404 via the search term user interface 400. For example, the personal information category may describe information that may be used to identify an individual (e.g., first name, date of birth, last name, phone number, email, or address). As another example, the health information category may describe health status of an individual (e.g., diagnoses, personal health information (PHI), medical records, or ICD codes). As yet another example, the financial information category may describe aspects of an individual's finances (e.g., account numbers and routing numbers). In still other examples, the security information category may apply to information such as IP addresses, usernames, passwords that may be used to access an individual's accounts, the national information may provide governmental ID numbers (tax ID, social security number, driver's license number, passport number), and sensitive information may describe an individuals sexual preferences, race, gender, political views, or religious views.

As another example, the user may enter within field 404 a search term “Social” to identify one or more data model field values integrated between two applications, enterprises, or trading partners that may include the social security number of an individual. Upon selection by the user at field 402 to include the search term “social” entered at field 404 in such an embodiment, the data integration protection assistance system may search data model fieldnames for all data model field values identified in each code set underlying the integration process. If a data model fieldname for any data model field value identified in these underlying code sets includes the term “social,” the data integration protection assistance system may label the data model field value having that data model fieldname as falling within the “national” sensitive information category.

Enterprises executing integration processes involving data model field values falling into one or more of these categories of potentially sensitive information may protect such data model field values through a variety of different means. For example, if a data model field value involved in an integration process is labeled as sensitive, an enterprise may apply a variety of protective measures ranging from application of a basic encryption of such data model field values to termination of a transfer of such a data model field value. The specific security measure chosen or applied in embodiments may depend upon the category in which the sensitive information falls. For example, an enterprise may choose to apply a lower level security measure to sensitive data identified as “personal,” and a higher level security measure to sensitive data identified as “financial.” By categorizing data model field values identified as containing sensitive information, based on user-specified search terms and categorizations, the data integration protection assistance system in an embodiment may assist enterprises in applying varying degrees of security measures in such a way.

FIG. 4B is a graphical diagram illustrating a user interface for entering terms describing data model fieldnames associated with data model field values not likely to contain potentially sensitive information for use in avoiding labeling of such data model field values as potentially sensitive according to an embodiment of the present disclosure. A user may also interact with the search term visual user interface 400 to define terms used to exclude data model fieldnames for consideration as identifying data model field values potentially containing sensitive information. For example, the user may exclude one or more search terms by selecting the “Manage” tab 410 in an embodiment. This capability may be used to narrow the scope of data model fieldnames the data integration protection assistance system in an embodiment must search during the process of identifying potentially sensitive information. For example, a user may provide a search term at field 408 that is used routinely to describe data model field values known to not contain personally identifiable information, then use the field 406 to indicate data model field values associated with data model fieldnames that include that search term should not be labeled as including sensitive information of any kind. For example, a user may use the search term visual user interface 400 to instruct the data integration protection assistance system not to label any data model field values having a data model fieldname that includes the term “.exe” as sensitive information. In such a way, the user may indicate to the data integration protection assistance system that executable files for publicly available and non-customized programs likely do not contain any individual personal information.

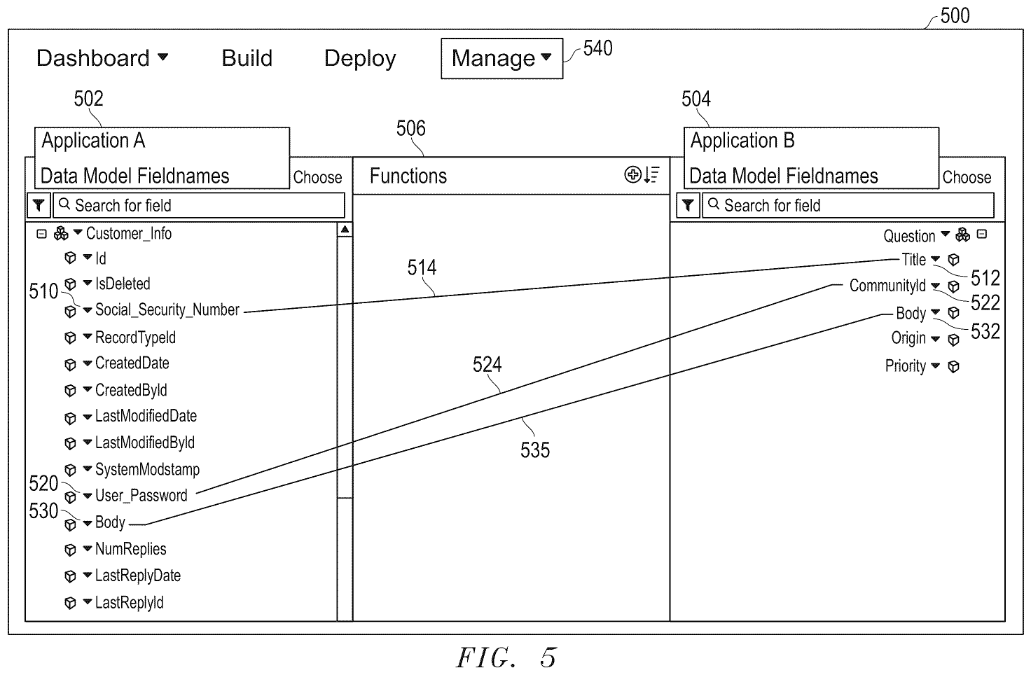

FIG. 5 is a graphical diagram illustrating fieldname lineage mapping between multiple data model fieldnames, each associated with a separate application for a single data model field value throughout an integration process according to an embodiment of the present disclosure. As described herein, in addition to labeling a data model field value as falling within one of the preset categories describing types of personal information, the data integration protection assistance system may also track the movement of such a data model field value throughout the integration process, to assist with the type or reporting required by the GDPR.

A fieldname lineage map may be displayed in an embodiment via a graphical user interface 500, which may correspond to the graphical user interfaces 300 and 400 described with reference to FIGS. 3A-3B, and 4A-4B, respectively. A user may create, view, or edit a fieldname lineage map in an embodiment by selecting the “Manage” tab 540 in an embodiment. An example fieldname lineage map in an embodiment may include a first column 502 listing one or more data model fieldnames for data model field values accessed, transmitted, copied, or otherwise manipulated by an “Application A,” and a column 504 listing one or more data model fieldnames for data model field values accessed, transmitted, copied, or otherwise manipulated by an “Application B.”

In some embodiments, a data model field value manipulated by Application A at one step within an integration process may also be manipulated by Application B at a later step within the same integration process. In other words, such an integration process in an embodiment may involve transmitting a data model field value from Application A to Application B. Thus, one or more of the data model fieldnames listed in column 502 may describe a data model field value that is also described by one or more of the data model fieldnames listed in column 504. For example, an integration process may include transmitting a data model field value that includes a social security number, having a data model fieldname “Social_Security_Number” 510, locatable by Application A, to Application B. Such an integration process may also involve storing the data model field value that includes the social security number under a data model fieldname “Title” 512, locatable by Application B. Thus, a single data model field value that includes a social security number may be given two separate data model fieldnames (e.g., “Social_Security_Number” 510, and “Title 512) at two separate points within the same integration process. In such an embodiment, the mapping user interface 500 may associate the data model fieldname “Social_Security_Number” 510 from column 502 with the data model fieldname “Title” 512 from column 504 using a mapping connector 514.

As described herein, users of the visual user interface describing the flow of the integration process may use map elements to associate a first data model fieldname for a data model field value being retrieved from a first application or source with a second data model fieldname under which that data model field value will be stored at a second application or destination. For example, a previously created map element may associate the data model fieldname “Social_Security_Number,” accessible by Application A with the data model fieldname “Title,” accessible by Application B. The data integration protection assistance system in an embodiment may use this previously created map element to make the link 514 between the data model fieldname “Social_Security_Number” 510 and the data model fieldname “Title” 512 within the fieldname lineage map.

Users may also provide, via the mapping element, an operation name that describes the purpose for changing the data model fieldnames of the data model field value in such a way. For example, the previously created mapping element may identify “Transfer of Vendor Contacts” as the operation for changing the data model fieldname of the data model field value transferred from Application to Application B from “Social_Security_Number” to “Title.” The data integration protection assistance system in some embodiments may list this user-defined operation identified within the mapping element within the functions column 506 of the fieldname lineage map.

In another example embodiment, Application A may provide a data model fieldname “User_Password” 520 to describe a data model field value that includes a user password, and Application B may provide a data model fieldname “CommunityID” 522 to describe the same data model field value. The fieldname lineage map in an embodiment may associate the data model fieldname “User_Password” 520 from column 502 with the data model fieldname “CommunityID” 522 from column 504 using a mapping connector 524. In still another example, Application A may provide a data model fieldname “Body” 530 to describe a data model field value for which Application B has also provided the data model fieldname “Body” 532. The fieldname lineage map in an embodiment may associate the data model fieldname “Body” 530 from column 502 with the data model fieldname “Body” 532 from column 504 using a mapping connector 535.

As described above with respect to FIGS. 4A and 4B, a data model field value may be labeled sensitive information falling into one or more user-defined categories (e.g., personal, financial, security, national, sensitive, or health). For example, a user in an embodiment may use the search term user interface to instruct the data integration protection assistance system to label data model field values having a data model fieldname including the search term “social” as sensitive information (e.g., under the “national” category that includes social security numbers). In such an embodiment, the data integration protection assistance system may consequently label the data model field value having the data model fieldname “Social_Security_Number” 510 as falling within the “national” category of sensitive information. However, the data integration protection assistance system in such an embodiment may not label the data model fieldname “title” 512 in such a manner pursuant to such a search, as it does not include the term “social” within the data model fieldname. In other words, using such a search method described with reference to FIGS. 4A and 4B alone, the same data model field value may be marked sensitive in one portion of an integration process, and not marked sensitive in a later portion of the same integration process. Thus, even after a data model field value is identified at a given step of such an integration process as “sensitive,” a method is needed to map the movement that data model field value through each application/location/enterprise involved in the process, and to mark the other data model fieldnames associated with this data model field value throughout the rest of the integration process as “sensitive,” even if these other data model fieldnames did not match the search terms used to identify the first data model fieldname as “sensitive.”

The fieldname lineage map in an embodiment may allow the data integration protection assistance system to map each data model fieldname given to a data model field value throughout an integration process, identifying which of these data model fieldnames was applied at each application/location/enterprise involved in the integration process, and the manipulation or action performed by each of these applications/locations/enterprises during the integration process. For example, after labeling the data model field value having the data model fieldname “Social_Security_Number” 512 as National sensitive information, the data integration protection assistance system in an embodiment may identify the link 514 between the data model fieldname 510 and the data model fieldname 512, and consequently also label the data model fieldname “Title” 512 as National sensitive information. As another example, after labeling the data model field value having the data model fieldname “User_Password” 520 as Security sensitive information, the data integration protection assistance system in an embodiment may identify the link 524 between the data model fieldname 520 and the data model fieldname 522, and consequently also label the data model fieldname “CommunityID” 522 as Security sensitive information.

Fieldname lineage maps generated in such a fashion may also streamline future searches across data model field value data model fieldnames. No uniform or standard applies to the selection of data model fieldnames. In some circumstances, naming conventions for data model fieldnames provide contextual indicators of the content of their associated data model field values, while in others, the data model fieldname provides little, no, or confusing contextual indicators of the content of an associated data model field value. For example, the data model fieldname “Social_Security_Number” 510 may contextually describe the contents of the data model field value, which includes a social security number, but the data model fieldname “Title” 512 may provide no contextual clue that the data model field value contains a social security number. A user attempting to label data model field values that may contain social security numbers may be likely to use a search term such as “social,” but would be unlikely to search for social security numbers using the search term “title.” However, if the data integration protection assistance system has already executed such a search, referenced the fieldname lineage map that links the data model fieldnames “Social_Security_Number” and “Title,” and labeled both data model fieldnames as National sensitive information, it may streamline future searches for the search term “social” to also identify the data model fieldname “Title.”

The data integration protection assistance system in an embodiment may streamline such future searches by associating a fieldname lineage map that contains any data model fieldname meeting a search term with both the search term and the label applied to all data model fieldnames identified within that fieldname lineage map. For example, in an embodiment in which a user wishes to label data model fieldnames including the search term “social” as National Sensitive information, the data integration protections assistance system may label the data model fieldname “Social_Security_Number” 510 as National Sensitive information. As described above, the data integration protection assistance system in such an embodiment may also label the data model fieldname “Title” 512 as National Sensitive information, based on the link 514 between the data model fieldnames 510 and 512. Further, the data integration protection assistance system in such an embodiment may then store an association between the fieldname lineage map linking the data model fieldnames “Social_Security_Number” 510 and “Title” 514 with both the search term “social,” and the user-defined label “National Sensitive.”

Following such an association between the fieldname lineage map and the user-defined search term and label, the data integration protection assistance system may receive a later user instruction to repeat the search for the term “social.” In such an embodiment, the data integration protection assistance system may determine this search term is associated with a previously stored fieldname lineage map, and automatically label all data model field values associated with all data model fieldnames found within that fieldname lineage map as meeting the user-defined label. In such a way, the data integration protection assistance system may streamline user searches based on contextual terms to also automatically identify data model fieldnames that do not include such contextual descriptors.

In some embodiments, the data integration protection assistance system may also employ a neural network or machine learning capabilities to anticipate non-contextually descriptive data model fieldnames that do not meet a user-defined search term, but are associated with data model field values still likely to contain information described by the user-defined search term. For example, the data integration protection assistance system in an embodiment may determine, through review of several fieldname lineage maps, that a data model fieldname “Social_Security_Number,” which contains a user-defined search term of “social,” is repeatedly linked to other data model fieldnames, including “SSN,” “UserID,” and “GovID.” Although the data model fieldnames “SSN,” “UserID,” and “GovID” do not include the search term “social,” a neural network operating within the data integration protection assistance system in such an embodiment may eventually learn to anticipate that a user attempting to apply a sensitive information label to data model field values associated with data model fieldnames meeting the search term “social” will also intend to apply that label to data model field values associated with the data model fieldnames “SSN,” “UserID,” and “GovID.” In such an embodiment, the data integration protection assistance system may either automatically apply such a label to data model field values associated with the data model fieldnames “SSN,” “UserID,” and “GovID,” or may suggest the inclusion of those search terms within the graphical user interface in which the user enters search terms. In such a way, the data integration protection assistance system may overcome the problem of non-contextual naming conventions.

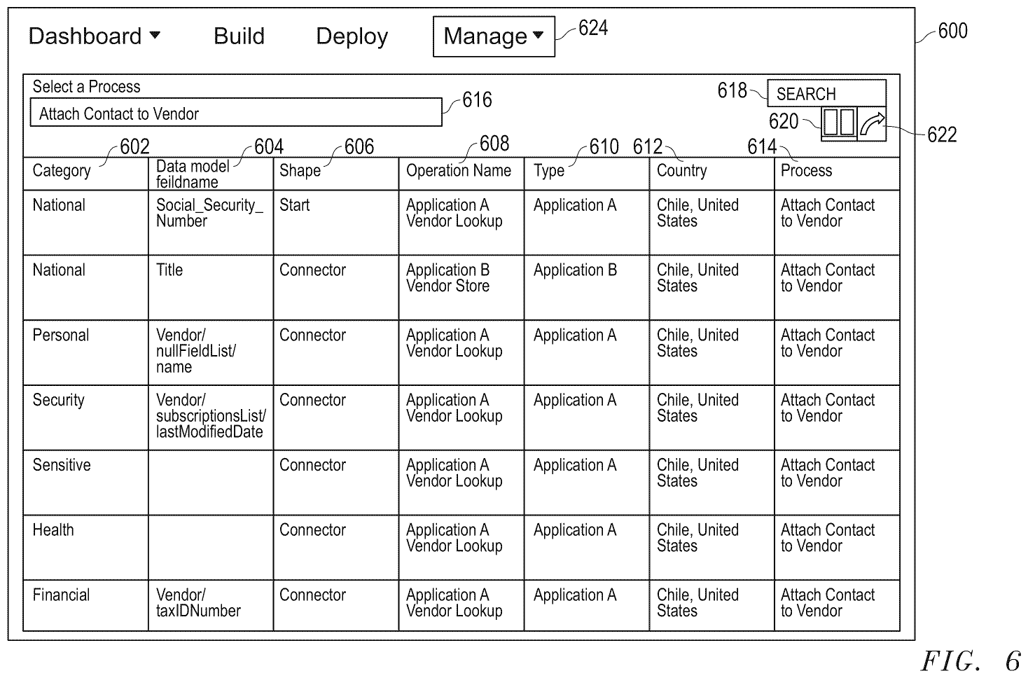

FIG. 6 is a graphical user interface for searching, displaying, and generating reports describing data model field values labeled as sensitive information that are involved in an integration process according to an embodiment of the present disclosure. As described herein, upon request of an EU citizen whose personal data has been included within an integration process, an adherent to the GDPR (e.g., entity performing data integration processes) must provide adequate explanation of the ways in which such personal data has been manipulated or transferred. In addition, one way for an enterprise system executing data integration processes to protect against infringement involves tracking the content of data model field values being integrated, and the ways in which such data is being manipulated.

Similar methods may also assist in deterring or lessening potentially hefty fines if an infringement should occur. The level of fine levied against a non-compliant entity is determined according to a variety of factors, that include the extent of the infringement (e.g., number of people affected and damage caused thereto), mitigating acts taken by the non-compliant entity following infringement, preventative measures taken by the non-compliant entity prior to the infringement, what types of data were impacted by the infringement, and whether the non-compliant entity promptly notified those who were affected by the infringement, among others. In the unfortunate event of an infringement, enterprises executing data integration processes may at least decrease the amount of the resultant penalties by providing detailed metrics describing data affected by each integration process, individuals whose information was incorporated within such data, and the ways in which such data was accessed, copied, transferred, or otherwise manipulated in an infringing integration process. Such detailed information may indicate preventative and mitigating measures were taken, and may assist in notification of individuals impacted.

FIG. 6 illustrates the display of information describing properties of data model field values and the ways in which an integration process manipulates such data model field values, in a searchable format, for easy generation of reports complying with GDPR requirements. For example, the graphical user interface 600 (which may correspond to the graphical user interfaces 300, 400, and 500 described with reference to FIGS. 3A-3B, 4A-4B, and 5, respectively) may allow a user to view certain properties of all data model field values labeled under any of the sensitive categories described herein occurring within a single integration process, or across a plurality of integration processes, by selecting the “Manage” button 624. A user may initiate a search for data model field values labeled as sensitive in an embodiment by selecting a process executed on one or more data model field values in one or more integration processes at the search field 616. For example, an integration process that involves transmitting a plurality of data model field values, each describing different contact information for a vendor, between a first application (e.g., NetSuite™) and a second application (e.g., SalesForce™). Such an integration process may be named “attach contact to vendor” in an embodiment. A user may search each of the data model field values transmitted between these applications pursuant to the “attach contact to vendor” process within the search field 616 in order to view a description of the ways in which that process manipulated data model field values identified as sensitive or likely to include personal information. In other embodiments, the user may search across multiple processes simultaneously to view descriptions of the ways in which multiple processes manipulate similarly labeled data model field values. In still other embodiments, the user may search across all integration processes, or may narrow search results generated with respect to one or more identified processes by entering a search term within the field 618.

The graphical user interface 600 in an embodiment may display information describing the types of data model field values labeled sensitive and the ways in which the selected integration processes manipulated such data model field values. For example, column 604 may identify the data model fieldname for each dataset labeled as sensitive information, and column 602 may list the category of sensitive information within which each data model field value falls, including personal, security, national, financial, sensitive, or health. As described herein, each of these categories is user-specified. Thus, other embodiments may include any category designation provided by a user, and each of these categories may be associated with preset, user-defined data model fieldname search terms. Although embodiments of the present disclosure describe search terms for identifying data model field values containing potentially sensitive personal information, it is contemplated that users may provide other search terms to identify data model field values for purposes other than security of personal information. For example, a user in an embodiment may provide a search term “http” and a user instruction to label data model fieldnames matching this search term as likely to be managed in a cloud computing space.

The graphical user interface 600 may further provide information regarding the ways in which the integration process identified in field 616 manipulated that data model field value. For example, column 606 may describe the shape of the visual element associated with the code instructions in which the data model fieldname listed in column 604 was identified pursuant to the user-defined search for sensitive information. More specifically, in an embodiment described with reference to FIG. 3A, each of the plurality of visual elements selected by the user for inclusion within the integration process modeled by the visual flow may be associated with executable code instructions. For example, the user may insert a start element 302 within a process flow for attaching contact information to a vendor to represent retrieving a data model field value associated with a data model fieldname “Social_Security_Number” from a first application (e.g., NetSuite™). As another example, the user may also insert a connector element 310 within the same process flow to represent transmitting the data model field value retrieved at element 302 to a second application (e.g., SalesForce™) and storing it with a data model fieldname “Title.” The user in such an embodiment may name the start element 302 “Application A vendor lookup,” and name the connector element 310 “Application B vendor store.” Each of these visual elements may represent a code set that identifies the data model field value being transmitted between Application A and Application B in an embodiment. For example, the start element 302 may represent executable code instructions for retrieving a data model field value having a data model fieldname “Social_Security_Number,” and the connector element 310 may represent executable code instructions for storing that same data model field value under a data model fieldname “Title.”

In an embodiment described with reference to FIG. 5, the data integration protection assistance system may identify both the data model field value associated with the data model fieldname “Social_Security_Number” 510 and the data model field value associated with its linked data model fieldname “Title” 512 as national sensitive information. This may be accomplished by searching the code instructions represented by the visual elements within the process flow for a user-specified search term (e.g., “social”). Returning to FIG. 6, in such an embodiment, the graphical user interface may display the data model field value having the data model fieldname “Social_Security_Number” as falling within the “National” category within the top row, and the (same) data model field value having the data model fieldname “Title” as falling within the “National” category within the second from the top row. In the top row, the graphical user interface 600 may associate the data model fieldname “Social_Security_Number” in column 606 with a visual element having a connector shape, because it is associated with the start element 302 within the modeled process flow, and may associate the data model fieldname “Title” with a connector shape, because it is associated with the connector element 310.

Column 608 in an embodiment may describe the name assigned to the visual element representing the code instructions in which the data model fieldname listed in column 604 was identified. For example, in the top row of the graphical user interface 600, the data model field value having the data model fieldname “Social_Security_Number” identified in the code instructions represented by the start element 302 may be associated in column 608 with the name “Application A vendor lookup,” that the user assigned to the visual element 302. As another example, in second from the top row of the graphical user interface 600, the data model field value having the data model fieldname “Title” identified in the code instructions represented by the connector element 310 may be associated in column 608 with the name “Application B vendor store,” that the user assigned to the connector element 310.

In an embodiment, a user may choose a process component it uses often when interfacing with a specific application, and define the parameters of that process component by providing parameter values specific to that application. If the user wishes to use this process component, tailored for use with that specific application repeatedly, the user may save that tailored process component and name it based on the specific application for which it is tailored. For example, if the user uses a process component for interfacing with NetSuite™ or SalesForce™ in several different integration processes, the user may wish to save this process component for later use by saving it as a NetSuite™ or SalesForce™ process component. In an embodiment, if a user has saved a connector element with a name identifying the application accessed by that connector element, the graphical user interface 600 may display that application name within column 610. For example, the user interface 600 may associate the connector element named “Application A vendor lookup,” as identified in the top row of column 608 with the type “Application A” in column 610. As another example, the user interface 600 may associate the connector element named “Application B vendor store,” as identified in the second to top row of column 608 with the type “Application B” in column 610.

Column 612 in an embodiment may identify a geographic location of a server where a data model field value identified as sensitive has been stored, pursuant to, or as described by the integration process selected by the user in field 616. For example, the integration process named “Attach Contact to Vendor” may execute code instructions to retrieve a data model field value having a data model fieldname “Social_Security_Number” from a NetSuite™ server located in Chile and transmit that data model field value for storage under the data model fieldname “Title” at a SalesForce™ server located in the United States. In such an embodiment, the graphical user interface 600 may list both the United States and Chile within the column 612.

In an embodiment in which a user searches across several processes using the search field 618, the graphical user interface 600 may display data model field values associated with data model fieldnames matching the user-provided search term that are the subject of a plurality of processes. In such an embodiment, the graphical user interface 600 may list each of these data model field values, and may associate the data model fieldnames for each of these data model field values given in column 604 with the name of the process, given in 614, in which that data model field value is accessed, transferred, copied, or otherwise manipulated.

A user may instruct the graphical user interface to display results in the tabular view shown in FIG. 6, or in a text format by toggling the display format button 620. Output of searches made using the graphical user interface 600 in an embodiment may be exported or printed in a variety of different coding languages. For example, a user in an embodiment could select one of the listed data model fieldnames or rows displayed in the graphical user interface, then instruct the data integration protection assistance system to export the code instructions where that data model fieldname was identified and labeled as sensitive information by selecting the export button 622. Upon selection of the export button 622 in an embodiment, the user may be prompted to choose from a plurality of coding formats (e.g., JSON, XML) in which the user wishes those code instructions to be displayed. A user may also export the entire tabular output of the information displayed within the graphical user interface 600 in some embodiments. In such a way, the data integration protection assistance system in an embodiment may provide a report of which data model field values containing personal information were accessed, transferred, or otherwise manipulated during an integration process and how, as well as the applications/locations/enterprises at which such access or manipulation occurred.

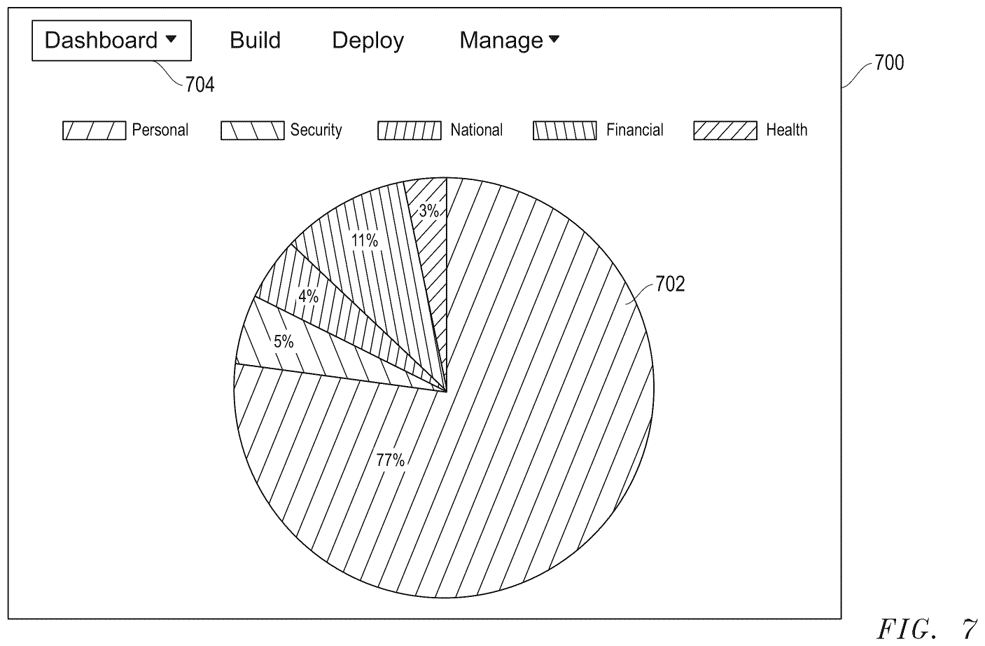

FIG. 7 is a graphical diagram illustrating a graphical user interface for viewing a proportion of data model field values subject to one or more integration processes labeled as including sensitive personal information according to an embodiment of the present disclosure. The information describing data model field values manipulated through one or more integration processes that have been labeled as sensitive personal information may also be displayed in graphical, rather than textual or tabular form. For example, the data integration protection assistance system in an embodiment may provide a graphical user interface 700 (which may correspond to the graphical user interfaces 300, 400, 500, and 600 described with reference to FIGS. 3A-3B, 4A-4B, 5, and 6, respectively). A user may view metrics associated with one or more integration processes in an embodiment by selecting the “Dashboard” button 704. In response, the data integration protection assistance system may display, via the graphical user interface 700, in pie chart form 702, what proportion of all data model field values manipulated during a given integration process contain sensitive personal information. Further, such a graphical user interface 700 may also indicate the proportion of all data model field values labeled as sensitive personal information that fall into each of the user-defined categories (e.g., personal, health, finance, national, security, sensitive).

In some embodiments, the pie chart 702 portion of the graphical user interface 700 may include search functionality, allowing a user to view the percentage of data model field values meeting a given search criteria transmitted during a given integration process. For example, in an embodiment in which a user has established a user-defined category for data model field values likely subject to U.S. Health Insurance Portability and Accountability Act (HIPAA) regulations, the graphical user interface 700 may display the percentage of all data model field values manipulated pursuant to a given integration process labeled as HIPAA sensitive. In other aspects of such an embodiment, the pie chart 702 may further break the number of data model field values labeled as HIPAA sensitive into portions of HIPAA sensitive data model field values that also fall within one or more of the other user-defined categories (e.g., personal, health, finance, national, security, sensitive).

Integration processes may be modeled within an enterprise by employees or individuals with technical knowledge. These same employees or individuals may not be responsible for adherence to the GDPR in some instances. Those responsible for such compliance may not, in usual business practice, have a thorough understanding of the types of data being accessed and manipulated during the integration processes modeled by employees with technical knowledge. However, those responsible for compliance may also be responsible for determining the amount of funding to apply toward securing integrated data, based on the likelihood of incurring GDPR penalties or fines. Thus, it may be useful to non-technical employees, otherwise unfamiliar with the finer details of the integration processes executed by her enterprise to understand the proportion of data model field values manipulated during such integration processes that may be subject to GDPR regulations. The pie chart 702 display may provide such high-level perspective to assist executives and officers in making such budgetary decisions regarding added security.

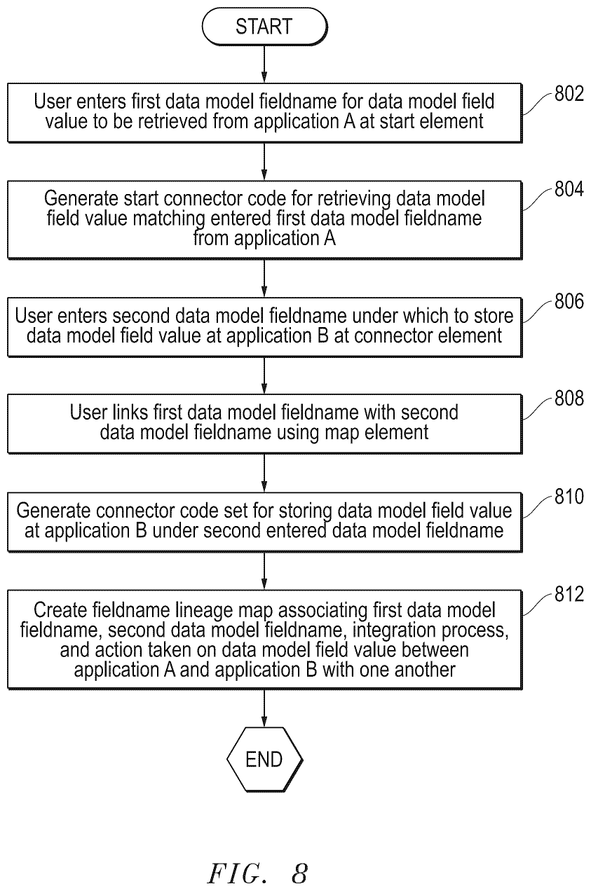

FIG. 8 is a flow diagram illustrating a method of mapping multiple data model fieldnames for a single data model field value integrated between multiple applications, locations, or enterprises together according to an embodiment of the present disclosure. At block 802, a user may enter a first data model fieldname for a data model field value to be retrieved from an application A at a start element of a visual flow chart in an embodiment. For example, in an embodiment described with reference to FIG. 3A, a user may insert a start element 302 within a process flow for attaching contact information to a vendor. In such an embodiment, the user may use start element 302 to identify a data model field value having a first data model fieldname to retrieve from an Application A. For example, the user may use start element 302 to identify a data model field value having a first data model fieldname “Social_Security_Number” from the NetSuite™ application.

The integration application management system in an embodiment may generate a start code set for retrieving the data model field value matching the entered first data model fieldname from Application A at block 804. As described herein, the integration application management system in an embodiment may associate each of the plurality of visual elements selected by the user for inclusion within the integration process modeled by the visual flow with executable code instructions. Each set of connector code instructions in an embodiment may include code instructions executable to perform an action on a data model field value (e.g., the data model field value matching the user-specified data model fieldname given in block 802). These code sets may be written in any programming code language.

At block 806, a user may enter, within a second connector element, a second data model fieldname under which to store the data model field value at Application B. For example, the user may insert a connector element 310 within the same process flow that includes start element 302 for attaching contact information to a vendor. The user may insert connector element 310 to represent transmitting the data model field value retrieved at element 302 to a second application. For example, the user may insert connector element 310 for transmitting the data model field value retrieved at element 302 to SalesForce™, and for storing it with a data model fieldname “Title.”

The integration application management system in an embodiment may receive a user instruction linking the first data model fieldname to the second data model fieldname via a map element at block 808. As described herein, users of the visual user interface describing the flow of the integration process may use map elements to associate a first data model fieldname for a data model field value being retrieved from a first application or source with a second data model fieldname under which that data model field value will be stored at a second application or destination. For example, in an embodiment described with reference to FIG. 5, a previously created map element may associate the data model fieldname “Social_Security_Number,” accessible by Application A with the data model fieldname “Title,” accessible by Application B. The data integration protection assistance system in an embodiment may use this previously created map element to make the link 514 between the data model fieldname “Social_Security_Number” 510 and the data model fieldname “Title” 512 within the fieldname lineage map.

The integration application management system in an embodiment may generate a connector code set for storing the data model field value at Application B under the second entered data model fieldname at block 810. The integration application management system in an embodiment may associate the connector visual element 310 with code instructions executable to perform an action (e.g., store) on a data model field value (e.g., the data model field value matching the user-specified data model fieldname given in block 804). As described herein, these code sets may be written in any programming code language. Thus, the process-representing elements in an embodiment may be programming language-agnostic. Using such process-representing elements in an embodiment, a user may model an end-to-end integration process between multiple applications that each use different naming conventions and storage structures for storage of data model field values. As a result, a single data model field value accessed at the start element 302 and transmitted to a second location at the connector element 310 in an embodiment may be identified at the start element 302 with a completely different data model fieldname (e.g., “Social_Security_Number”) than the data model fieldname (e.g., “Title”) used to identify the exact same data model field value at the connector element 310.

At block 812, the data integration protection assistance system in an embodiment may create a fieldname lineage map associating the first data model fieldname, second data model fieldname, integration process, and action to be taken on the data model field value between Application A and Application B with one another. For example, in an embodiment described with reference to FIG. 5, the data integration protection assistance system may map each data model fieldname given to a given data model field value throughout an integration process, based on user-defined links provided via the map element in block 808. Such a fieldname lineage map in an embodiment may identify which of these data model fieldnames was applied at each application/location/enterprise involved in the integration process, and the manipulation or action (e.g., listed within column 506) performed by each of these applications/locations/enterprises during the integration process. More specifically, the data integration protection assistance system in an embodiment may map a link 514 between the data model fieldname “Social_Security_Number” 510 used by the NetSuite™ application to describe a data model field value, and the data model fieldname “Title” 512 used by the SalesForce™ application to describe the same data model field value. In such a way, the data integration protection assistance system may track all data model fieldnames given to a single data model field value throughout an integration process in an embodiment. The method may then end.

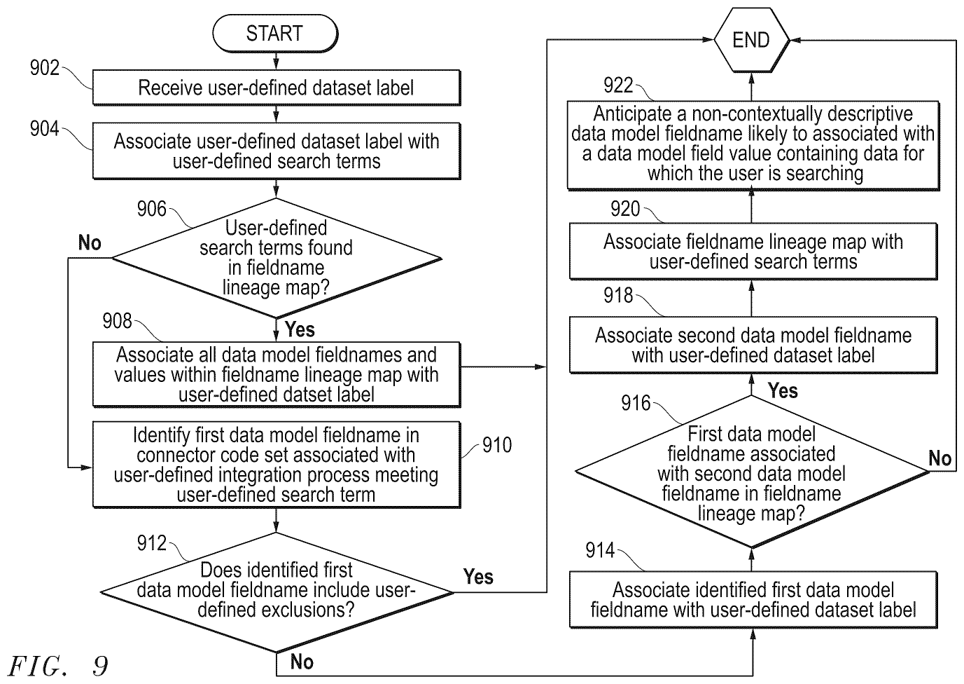

FIG. 9 is a flow diagram illustrating a method of labeling a data model field value having multiple data model fieldnames in a single integration process as sensitive personal information according to an embodiment of the present disclosure. As described herein, a single data model field value may receive multiple data model fieldnames throughout a single integration process. It may be determined whether a data model field value is likely to include sensitive personal information via a search of the data model fieldnames given to data model field values involved in an integration process for certain keywords used frequently to describe such sensitive information (e.g., “social,” “taxID,” “Shipping_Address,” etc.). However, because a single data model field value may receive multiple data model fieldnames throughout an integration process, only a portion of the data model fieldnames used to describe a data model field value may be identified using such a search. Consequently, using such a search method alone, a data model field value may be identified as potentially containing sensitive information during an early step in an integration process, but not containing sensitive information during a later step, despite the fact the data model field value has not been altered between these steps. FIG. 9 illustrates a method for consistently labeling a data model field value that may contain sensitive private information throughout each step of an integration process, despite any changes in data model fieldnames describing that data model field value that may occur.

At block 902, the data integration protection assistance system in an embodiment may receive a user-defined dataset label. As described herein, one way for an enterprise system executing data integration processes to protect against GDPR infringement involves tracking the content of data model field values being integrated, and the ways in which such data is being manipulated. For example, an ability to identify sensitive information and apply added security measures to integration processes involving such sensitive information may lessen the risk of infringement. As a first step in such a protection process, data may be sorted in several categories describing different types of sensitive personal information. For example, sensitive information in some embodiments may receive a label identifying a data model field value as falling within one of a plurality of types of sensitive information, including personal data, sensitive data, security data, health data, financial data, or national data. Each of these categories is user-specified. It is contemplated that a user may provide other categories for other purposes. For example, a user may provide categories separating cloud-based transactions from intra-enterprise transactions.

The data integration protection assistance system in an embodiment may associate the user-defined dataset label with a user-defined search term at block 904. For example, in an embodiment described with reference to FIG. 4A, a user may associate search terms provided at field 404 of the search term graphical user interface 400 with one or more specific categories of personal information. The user may associate the personal information category with search terms that may describe information that may be used to identify an individual (e.g., first name, date of birth, last name, phone number, email, or address). As another example, the user may associate the health information category with search terms that may describe health status of an individual (e.g., diagnoses, personal health information (PHI), medical records, or ICD codes). As yet another example, the user may associate the financial information category with search terms that may be used to describe aspects of an individual's finances (e.g., account numbers and routing numbers). In still other examples, the user may associate the security information category with search terms such as IP addresses, usernames, passwords that may be used to access an individual's accounts, the national information with search terms for governmental ID numbers (tax ID, social security number, driver's license number, passport number), and sensitive information with search terms that may describe an individuals sexual preferences, race, gender, political views, or religious views.

As a more specific example, the user may enter within field 404 a search term “Social” to identify one or more data model field values integrated between two applications, enterprises, or trading partners that may include the social security number of an individual. Upon selection by the user at field 402 to include the search term “social” entered at field 404 in such an embodiment, the data integration protection assistance system may search data model fieldnames for all data model field values identified in each code set underlying the integration process. If a data model fieldname for any data model field value identified in these underlying code sets includes the term “social,” the data integration protection assistance system may label the data model field value having that data model fieldname as falling within the “national” sensitive information category.

Again, each of these dataset label categories may be user-defined. Thus, other embodiments may include any category designation provided by a user, and each of these categories may be associated with preset, user-defined data model fieldname search terms. Although embodiments of the present disclosure describe search terms for identifying data model field values containing potentially sensitive personal information, it is contemplated that users may provide other search terms to identify data model field values for purposes other than security of personal information. For example, a user in an embodiment may provide a search term “http” and a user instruction to label data model field values associated with data model fieldnames matching this search term as likely to be managed in a cloud computing space.

At block 906, the data integration protection assistance system in an embodiment may determine whether the user-defined search term is associated with a stored fieldname lineage map. In an embodiment, a fieldname lineage map may track a plurality of data model fieldnames given to a single data model field value throughout an integration process. For example, in an embodiment described with reference to FIG. 5, a fieldname lineage map may link 514 the data model fieldname “Social_Security_Number” 510 with the data model fieldname “Title” 512. In some embodiments, if one or more of these data model fieldnames given within a fieldname lineage map met a search term in a previously executed search term (e.g., “Social_Security_Number” 510 met the search term “social”), the data integration protection assistance system may have stored an association between that entire fieldname lineage map and that search term. If this scenario has previously occurred, and the user-defined search term is associated with a pre-existing fieldname lineage map, the method may proceed to block 908 for labeling of the data model field values associated with each of the data model fieldnames within the fieldname lineage map. If the user-defined search term is not associated with a pre-existing fieldname lineage map, the method may proceed to block 910.

The data integration protection assistance system in an embodiment may associate the user-defined dataset label with data model field values of all data model fieldnames within a pre-existing fieldname lineage map associated with the user-defined search terms at block 908. For example, in an embodiment described with reference to FIG. 5, in which the data integration protection assistance system determines the fieldname lineage map is associated with the search term “social,” the data integration protection assistance system may automatically associate the data model field values associated with the data model fieldnames “Social_Security_Number” and “Title” with the user-specified data label “National Sensitive” information. In such a way, the data integration protection assistance system may streamline user searches based on contextual terms (e.g., “social”) to also automatically identify data model field values associated with data model fieldnames that do not include such contextual descriptors (e.g., “Title”). The method may then end.

At block 910, the data integration protection assistance system in an embodiment may identify a first data model fieldname in a connector code set associated with the user-defined integration process meeting the user-defined search term. The data integration protection assistance system may search code instructions for one or more integration processes to identify data model field values accessed, copied, transferred, or otherwise manipulated therein that may contain sensitive information by searching code instructions including data model fieldnames and metadata of data model field values accessed, copied, transferred, or otherwise manipulated throughout an integration process, for the user-provided search terms. For example, in an embodiment described with reference to FIG. 3A, the user may insert a start element 302 within a process flow for attaching contact information to a vendor to represent retrieving a data model fieldname “Social_Security_Number” from a first application (e.g., NetSuite™). As another example, the user may also insert a connector element 310 within the same process flow to represent transmitting the data model field value retrieved at element 302 to a second application (e.g., SalesForce™) and storing it with a data model fieldname “Title.” Each of these visual elements may represent a code set that identifies the data model field value being transmitted between Application A and Application B in an embodiment. For example, the start element 302 may represent executable code instructions for retrieving a data model field value having a data model fieldname “Social_Security_Number,” and the connector element 310 may represent executable code instructions for storing that same data model field value under a data model fieldname “Title.” The data integration protection assistance system in such an embodiment may search each of these executable code instructions for the search term “social” at block 910. For example, the data integration protection assistance system in such an embodiment may identify the term “social” within the data model fieldname “Social_Security_Number” listed in the code instructions associated with Application A (e.g., NetSuite™).

The data integration protection assistance system in an embodiment may determine at block 912 whether the identified first data model fieldname includes user-defined exclusions. As described herein with reference to FIG. 4B, a user may use the search term graphical user interface 400 to define terms used to exclude data model fieldnames for consideration as potentially containing sensitive information. For example, a user may provide a search term at field 408 that is used routinely to describe data model field values known to not contain personally identifiable information (e.g., “.exe”), then use the field 406 to indicate data model fieldnames that include that search term should not be labeled as including sensitive information of any kind. In such a way, the user may indicate to the data integration protection assistance system that executable files for publicly available and non-customized programs likely do not contain any individual personal information. The data integration protection assistance system at block 912 may determine whether the first data model fieldname identified at block 910 contains any of such user-provided exclusions. If the first data model fieldname includes one of the user-defined exclusions, this may indicate the data model field value associated with the data model field value identified at block 910 likely does not contain sensitive personal information, and the method may end. If the first data model fieldname does not include one of the user-defined exclusions, this may indicate the data model field value associated with the data model fieldname identified at block 910 likely contains sensitive personal information, and the method may proceed to block 914 for appropriate labeling of that data model field value.

At block 914, the data integration protection assistance system in an embodiment in which the first data model fieldname does not include a user-defined exclusion may associate the identified first data model fieldname with a user-defined dataset label. For example, in an embodiment described with reference to FIG. 3A, upon identifying the term “social” within the data model fieldname “Social_Security_Number” listed in the code instructions associated with Application A (e.g., NetSuite™), the data integration protection assistance system in an embodiment may label the data model field value named “Social_Security_Number” as falling within the “national” sensitive information category, for example. In such a way, the data integration protection assistance system in an embodiment may highlight a data model field value that is likely to contain sensitive personal information for an individual. However, as described herein, by following the steps described in blocks 910-914 in such a manner, the data integration protection assistance system in such an embodiment may also have failed to label the same data model field value in an earlier or later step of the integration process in which the common data model field value received another data model fieldname of “Title,” because that data model fieldname did not include the search term “social.” The remaining blocks of FIG. 9 may remedy this discontinuity in an embodiment.

The data integration protection assistance system in an embodiment may determine whether the first data model fieldname is associated with a second data model fieldname within a fieldname lineage map at block 916. For example, in an embodiment described with reference to FIG. 5, a single data model field value that includes a social security number may be given two separate data model fieldnames (e.g., “Social_Security_Number” 510, and “Title” 512) at two separate points within the same integration process. In such an embodiment, the mapping user interface 500 may associate the data model fieldname “Social_Security_Number” 510 from column 502 with the data model fieldname “Title” 512 from column 504 using a mapping link 514. The data integration protection assistance system in such an embodiment may determine at block 912 that the data model fieldname “Social_Security_Number” 510 identified at block 910 is associated with the data model fieldname “Title” 512 via the mapping link 514 within the fieldname lineage map. If the first data model fieldname is associated with a second data model fieldname via a mapping link, the method may proceed to block 918 for appropriate labeling of the data model field value associated with the second data model fieldname. If the first data model fieldname is not associated with a second data model fieldname via a mapping link at 916, the data integration protection assistance system may have successfully labeled all data model field values likely to include sensitive personal information, and the method may end.

At block 918, the data integration protection assistance system in an embodiment in which the first data model fieldname is linked to a second data model fieldname may associate the data model field value associated with the second data model fieldname with the user-defined dataset label applied to the data model field value associated with the first data model fieldname. For example, in an embodiment described with reference to FIG. 5, the data integration protection assistance system may label the data model field value having the data model fieldname “Title” 512 as falling within the “national” sensitive information category, despite the fact that the data model fieldname “Title” 512 does not contain the search term “social.” This may occur due to the fact that the data model fieldname “Title” 512 is associated via link 514 with the data model fieldname “Social_Security_Number” 510 that does match the search term “social.” In such a way, the data integration protection assistance system in an embodiment may label data model field values associated with likely to contain sensitive personal information, throughout an integration process.

The data integration protection assistance system in an embodiment may associate the fieldname lineage map with the user-defined search terms at block 920. Fieldname lineage maps may streamline future searches across data model fieldnames. In some circumstances, naming conventions provide contextual indicators of the content of such files, while in others, the name applied to a file provides little, no, or confusing contextual indicators of that file's contents. For example, in an embodiment described with reference to FIG. 5, the data model fieldname “Social_Security_Number” 510 may contextually describe the contents of the data model field value, which includes a social security number, but the data model fieldname “Title” 512 may provide no contextual clue that the data model field value contains a social security number. A user attempting to label data model field values that may contain social security numbers may be likely to use a search term such as “social,” but would be unlikely to search for social security numbers using the search term “title.” However, if the data integration protection assistance system has already executed such a search, referenced the fieldname lineage map that links the data model fieldnames “Social_Security_Number” and “Title,” and labeled both data model fieldnames as National sensitive information, it may streamline future searches for the search term “social” to also identify the data model fieldname “Title.”

The data integration protection assistance system in an embodiment may streamline such future searches by associating a fieldname lineage map that contains any data model fieldname meeting a search term with both the search term and the label applied to data model field values for all data model fieldnames identified within that fieldname lineage map. For example, in an embodiment in which a user wishes to label data model field values associated with data model fieldnames including the search term “social” as National Sensitive information, the data integration protections assistance system may label the data model fieldname “Social_Security_Number” 510 as National Sensitive information. As described above, the data integration protection assistance system in such an embodiment may also label the data model fieldname “Title” 512 as National Sensitive information, based on the link 514 between the data model fieldnames 510 and 512. Further, at block 920 the data integration protection assistance system in such an embodiment may then store an association between the fieldname lineage map linking the data model fieldnames “Social_Security_Number” 510 and “Title” 514 with both the search term “social,” and the user-defined label “National Sensitive.”

As described above with reference to blocks 906 and 908, once such an association has been made, in future search executions, the data integration protection assistance system may automatically label each of the data model fieldnames within the fieldname lineage map with the user-defined label. This may circumvent the need to execute steps 910-918 in such an embodiment. In such a way, the data integration protection assistance system in an embodiment may streamline such future searches.

At block 922, the data integration protection assistance system may employ a neural network or machine learning capabilities to anticipate non-contextually descriptive data model fieldnames that do not meet a user-defined search term, but are still likely to contain information described by the user-defined search term. For example, the data integration protection assistance system in an embodiment may determine, through review of several fieldname lineage maps, that a data model fieldname “Social_Security_Number,” which contains a user-defined search term of “social,” is repeatedly linked to other data model fieldnames, including “SSN,” “UserID,” and “GovID.” Although the data model fieldnames “SSN,” “UserID,” and “GovID” do not include the search term “social,” a neural network operating within the data integration protection assistance system in such an embodiment may eventually learn to anticipate that a user attempting to apply a sensitive information label to data model field values associated with data model fieldnames meeting the search term “social” will also intend to apply that label to the data model field values associated with the data model fieldnames “SSN,” “UserID,” and “GovID.” In such an embodiment, the data integration protection assistance system may either automatically apply such a label to the data model field values associated with the data model fieldnames “SSN,” “UserID,” and “GovID,” or may suggest the inclusion of those search terms within the graphical user interface in which the user enters search terms. In such a way, the data integration protection assistance system may overcome the problem of non-contextual naming conventions.

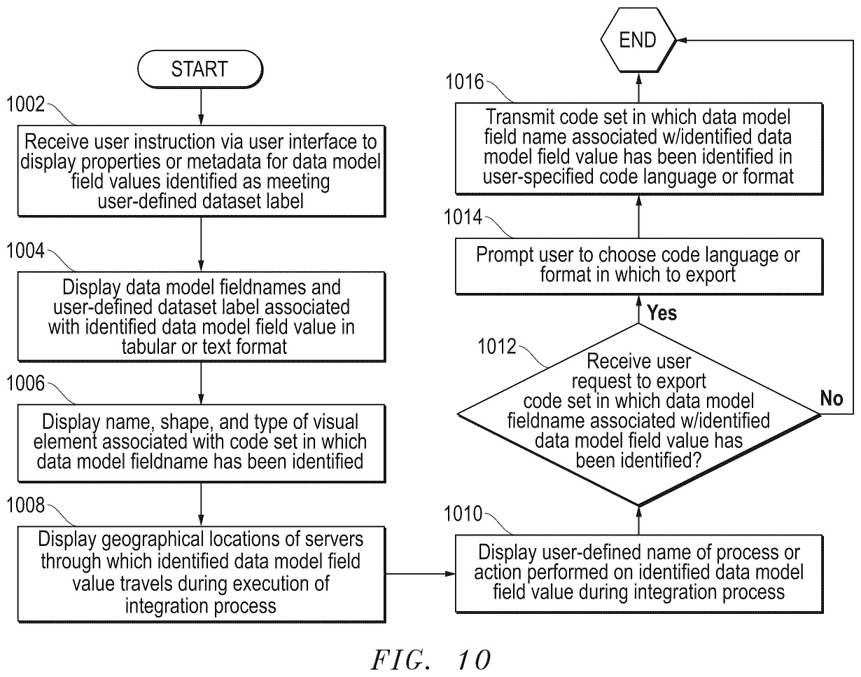

FIG. 10 is a flow diagram illustrating a method of generating a report describing properties of a data model field value labeled as sensitive personal information and the ways in which that data model field value has been manipulated in one or more integration processes according to an embodiment of the present disclosure. As described herein, one way for an enterprise system executing data integration processes to protect against infringement, and mitigate fines if an infringement occurs, involves tracking the content of data model field values being integrated, and the ways in which such data is being manipulated. Such detailed information may indicate preventative and mitigating measures were taken, and may assist in notification of individuals impacted, resulting in lower fines.

At block 1002, the data integration protection assistance system in an embodiment may receive a user instruction to display properties or metadata for data model field values identified as meeting user-defined dataset labels. For example, in an embodiment described with reference to FIG. 6, a user may initiate a search for data model field values labeled as sensitive in an embodiment by selecting a process executed on one or more data model field values in one or more integration processes at the search field 616. More specifically, a user may search each of the data model field values manipulated during an integration process called “attach contact to vendor” that involves transmitting a plurality of data model field values, each describing different contact information for a vendor, between a first application (e.g., NetSuite™) and a second application (e.g., SalesForce™), by entering the search phrase “attach contact to vendor” within the search field 616.

In other embodiments, the user may search across multiple processes simultaneously to view descriptions of the ways in which multiple processes manipulate similarly labeled data model field values. For example, a user may search across a plurality of processes for a given data label category (e.g., personal, security, national, financial, sensitive, or health) by entering that data label category within the search field 618. In another aspect of such an embodiment, the user may search for such a data label category within a single integration process by entering the data label category within the search field 618, and entering the name of the integration process within field 616. In still other embodiments, the user may search across one or more integration processes for a data model fieldname, a shape of a visual element, a name of a sub-process, the type or name of a source or destination for a migrating data model field value, or geographic locations at which data model field values have been stored by entering a search term within the field 618.

The data integration protection assistance system in an embodiment may display data model fieldname and user-defined dataset labels associated therewith in a tabular or text format at block 1004. For example, the graphical user interface 600 in an embodiment may display information describing the types of data model field values labeled sensitive and the ways in which the selected integration processes manipulated such data model field values. More specifically, column 604 may identify the data model fieldname for each data model field value labeled as sensitive information, and column 602 may list the category of sensitive information within which each data model field value falls, including personal, security, national, financial, sensitive, or health. The data model fieldnames displayed within the graphical user interface 600 in such an embodiment may be limited to those meeting search terms provided by the user in fields 616 or 618. By displaying only data model fieldnames meeting user-defined search terms supplied at fields 616 or 618 in such an embodiment, a manager or officer of an enterprise who is not intimately familiar with the code instructions of low diagram forming the basis of the integration process may view a high-level summary of the types of data model field values being transmitted pursuant to such an integration process or processes. This type of high-level summary information may be useful to determining where and how to direct financial resources toward securing certain types of information.

At block 1006, the data integration protection assistance system may display the name, shape, and type of visual element associated with the code set in which the fieldname has been identified. For example, the graphical user interface 600 may further provide information regarding the ways in which the integration process identified in field 616 manipulated that data model field value. More specifically, column 606 may describe the shape of the visual element associated with the code instructions in which the data model fieldname listed in column 604 was identified pursuant to the user-defined search for sensitive information. For example, column 606 may indicate the code instructions in which the data integration protection assistance system identified the data model fieldname “Social_Security_Number” are associated with a visual element in a process modeling user interface having a “start” shape, a user-defined name of “Application A vendor lookup,” and a type “Application A.”

The data integration protection assistance system in an embodiment may display the geographical locations of servers through which data model field values having identified data model fieldnames have traveled during execution of an integration process at block 1008. For example, column 612 in an embodiment may identify a geographic location of a server where a data model field value identified as sensitive has been stored, pursuant to, or as described by the integration process selected by the user in field 616. More specifically, the integration process named “Attach Contact to Vendor” may execute code instructions to retrieve a data model field value having a data model fieldname “Social_Security_Number” from a NetSuite™ server located in Chile and transmit that data model field value for storage under the data model fieldname “Title” at a SalesForce™ server located in the United States. In such an embodiment, the graphical user interface 600 may list both the United States and Chile within the column 612.

At block 1010, the data integration protection assistance system in an embodiment may display a user-defined name of a process or action performed on a data model field value having the identified data model fieldname during an integration process. For example, in an embodiment in which a user searches across several processes using the search field 618, the graphical user interface 600 may display data model fieldnames matching the user-provided search term that are the subject of a plurality of processes. In such an embodiment, the graphical user interface 600 may list each of these data model field values, and may associate the data model fieldnames for each of these data model field values given in column 604 with the name of the process, given in 614, in which that data model field value is accessed, transferred, copied, or otherwise manipulated.

In some embodiments, the data integration protection assistance system may display the information meeting user-specified search terms entered at fields 616 or 618 in graphical, rather than tabular form. For example, in an embodiment described by reference to FIG. 7, a pie-chart may display the proportion of data model field values meeting a user-specified search term are transferred during execution of one or more integration processes. By following the method described at blocks 1002-1010, a high-level summary describing properties of data model field values of interest to a manager or officer of an enterprise (e.g., data model field values potentially containing sensitive personal information on an individual) may be generated. As described herein, such high-level reports, in tabular, text, or graphical format may assist managers in making high-level decisions such as budgeting for security, and in complying with any reporting requirements associated with the GDPR or other regulatory bodies.

In some embodiments, a user may wish to view the code instructions underlying the portion of an integration process that manipulates a data model field value associated with a data model fieldname meeting user-defined search criteria. For example, in an embodiment, the graphical user interface 600 may display a data model field value falling within the “National” category. The user may also wish to view or export the code instructions operating to retrieve one of these data model field values (e.g., the data model field value having a data model fieldname “Social_Security_Number”) from a source, for example. The ability to view and export such code instructions in an embodiment may assist with future edits to the integration process executing such code instructions (e.g., to avoid such a retrieval under certain high-risk situations), or in complying with GDPR reporting requirements. Blocks 1012-1016 in an embodiment describe a method for the viewing or exportation of such code instructions.

The data integration protection assistance system in an embodiment may determine whether it has received a user request to export a code set in which the data model fieldname has been identified at block 1012. Output of searches made using the graphical user interface 600 in an embodiment may be exported or printed in a variety of different coding languages. For example, a user in an embodiment could select one of the listed data model fieldnames or rows displayed in the graphical user interface, then instruct the data integration protection assistance system to export the structured data where that data model fieldname was identified and labeled as sensitive information by selecting the export button 622. If the user selects the export button 622, and the data integration protection assistance system receives the user command to export, the method may proceed to block 1012 for identification of an exporting format. If the user does not select the export button 622, this may indicate the user does not wish to export the code instructions in which the selected data model fieldname was identified. Alternatively, the user may choose instead to print the full tabular report shown in FIG. 6 for GDPR compliance. The method may then end.

At block 1014, in an embodiment in which a user request to export a code set has been received, the data integration protection assistance system may prompt the user to choose a code language or format in which to export the code instructions. Upon selection of the export button 622 in an embodiment, the user may be prompted to choose from a plurality of coding formats in which the user wishes those code instructions to be displayed. For example, the user may be prompted to select from a drop-down list of available formats that include standard machine-executable coding languages (e.g., JSON, XML).

The data integration protection assistance system in an embodiment may transmit the code set in which the data model fieldname has been identified in the user-specified code language or format at block 1012. Upon receipt of the user-selected coding language, the data integration protection assistance system in an embodiment may retrieve the code instructions associated with the user-selected and search integration process from the service provider server/system. In some embodiments, the data integration protection assistance system may also translate the code instructions as they are stored in a first coding language (e.g., XML) at the service provider server/system to the user-specified coding language (e.g., JSON). The data integration protection assistance system in an embodiment may then export the code instructions, in the user-specified coding language to the user at the user device. In such a way, the data integration protection assistance system in an embodiment may provide a report of which data model field values containing personal information were accessed, transferred, or otherwise manipulated during an integration process and how, as well as the applications/locations/enterprises at which such access or manipulation occurred.

The blocks of the flow diagrams 8-10 discussed above need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram. Further, those of skill will understand that additional blocks or steps, or alternative blocks or steps may occur within the flow diagrams discussed for the algorithms above.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system operating a business integration application management system comprising:
a processor executing code instructions of the business integration application management system for modelling an end to end business integration process via the series of process-representing visual elements linked in a modelling graphical user interface by a user to generate an executable set of runtime code instructions for the end to end business integration process that includes transferring and renaming business data sets retrieved from a first data set field value from a source storage location in a first data format to a destination storage location identified by the second data field name in the second data format;
the processor generating a mapping process-representing visual element linked among the series of process-representing visual elements for a field name mapping linking, using a data naming lineage map, the first data set field name and the second data set field name;
the processor receiving a user instruction to search data set field names in the end to end business integration process; and
the processor to configure the mapping process-representing visual element to label business data sets that are migrated during execution of the runtime code instructions generated for the modeled end to end business integration process as well as the first data set field name and the second data set field name with a sensitive private individual data label when the first data set field name incorporates a search term indicating a private individual data category but the second data set field name linked to the first data set field name via the data naming lineage map does not incorporate the search term indicating the private individual data category at the second data field name, wherein the data naming lineage map and the sensitive private individual data label are used track migration of the business data sets containing sensitive personal information during execution of the runtime code instructions generated for the end to end business integration process.

2. The information handling system of claim 1 further comprising:
the processor executing code instructions of a data integration protection assistance system generating a tracking graphical user interface for tracking migration of at least one data set field value in the business data sets containing sensitive personal information during the execution of the runtime code instructions generated for the end to end business integration process.

1. The information handling system of claim 2 further comprising:
the processor executing code instructions of the data integration protection assistance system generating the tracking graphical user interface displaying a description of the renaming of the data set field value during the end to end business integration process.

2. The information handling system of claim 2 further comprising:
the processor executing code instructions of the data integration protection assistance system generating the tracking graphical user interface displaying a description of a process performed on the data set field value within the runtime code instructions of the end to end business integration process.

5. The information handling system of claim 2 further comprising:
the processor executing code instructions of the data integration protection assistance system generating the tracking graphical user interface displaying a name of an individual included within the business data set migrated from a first data field name to a second data field name.

6. The information handling system of claim 1 further comprising:
the processor executing an editing of the code instructions for the mapping process-representing visual element in the end to end data integration process to encrypt at least a portion of at least one data set field value in the business data sets to be migrated.

7. The information handling system of claim 1 further comprising:
a network interface device transmitting the runtime code instructions to a remote user location for execution of the runtime code instructions of the end to end business integration at a preset, later-scheduled time.

8. The information handling system of claim 1 further comprising:
the processor to configure the mapping process-representing visual element to label business data sets that are migrated during execution of the runtime code instructions generated for the modeled end to end business integration process as well as the first data set field name and the second data set field name with a does not contain sensitive private individual data label when the first data set field name incorporates a second search term indicating one of a plurality of dataset field names within the data lineage map as not containing sensitive private individual data; and
the processor labeling the one of the plurality of dataset field names within the data lineage map as not containing sensitive private individual data.

9. The information handling system of claim 1 further comprising:
the processor to execute code instructions of the business integration application management system for modeling a second end to end business integration process having data set field names that incorporate the search term as indicating the sensitive private individual data category;
the processor determining the second data integration process includes transmitting a migrating data set having the first data set field name; and
automatically labeling the migrating data set having the first data set field name as sensitive private individual data.

10. A method for visually modelling an end to end business integration process and tracking data migration comprising:
executing code instructions, via a hardware processor, of a business integration application management system for visually modelling an end to end business integration process via the series of process-representing visual elements linked in a modelling graphical user interface by a user to generate an executable set of runtime code instructions for the end to end business integration process that includes transferring and renaming business data sets retrieved from a first data set field value from a source storage location in a first data format to a destination storage location identified by the second data field name in the second data format;
generating a mapping process-representing visual element linked among the series of process-representing visual elements for a field name mapping linking, using a data naming lineage map, the first data set field name and the second data set field name;
configuring the mapping process-representing visual element to label business data sets that are migrated during execution of the runtime code instructions generated for the modeled end to end business integration process as well as the first data set field name and the second data set field name based on the data naming lineage map with a sensitive private individual data label when the first data set field name incorporates a search term that indicates a private individual data category; and
executing code instructions of a data integration protection assistance system generating a tracking graphical user interface for tracking migration of at least one data set field value in the business data sets containing sensitive personal information via the data naming lineage map and the sensitive private individual data label during the execution of the runtime code instructions generated for the end to end business integration process.

11. The method of claim 10 further comprising:
displaying, via the tracking graphical user interface, field names for each data set within the data lineage map, including the first data set field name and the second data set field name with private individual data labels to track migration of one or more data set field values in the business data sets containing sensitive personal information that is renamed during the end to end business integration process.

12. The method of claim 10 further comprising:
displaying, via the tracking graphical user interface, a description of the renaming of the data set field value during the first integration process.

13. The method of claim 10 further comprising:
displaying, via the tracking graphical user interface, a description of a process performed on the data set field value within the code instructions of the first integration process, via the graphical user interface.

14. The method of claim 10 further comprising:
displaying, via the tracking graphical user interface, a displaying a name of an individual included within the data set field value.

15. The method of claim 10 further comprising:
editing, via the processor, the code instructions for the mapping process-representing visual element of the end to end business integration process to encrypt at least a portion of the data set field value when the first data set field name incorporates a search term that indicates a private individual data category; and
transmitting the code instructions, and a run-time engine, via a network interface device, to a remote user location for execution of the code instructions by the run-time engine at a preset, later-scheduled time.

16. An information handling system operating a business integration application management system comprising:
a processor executing code instructions of the business integration application management system for modelling an end to end business integration process via the series of process-representing visual elements linked in a modelling graphical user interface by a user to generate an executable set of runtime code instructions for the end to end business integration process that includes transferring and renaming business data sets retrieved from a first data set field value from a source storage location in a first data format to a destination storage location identified by the second data field name in the second data format;
the processor generating a mapping process-representing visual element linked among the series of process-representing visual elements for a field name mapping linking, using a data naming lineage map, the first data set field name and the second data set field name;
the processor receiving a user instruction to search data set field names in the end to end business integration process;
the processor to configure the mapping process-representing visual element to label business data sets that are migrated during execution of the runtime code instructions generated for the modeled end to end business integration process as well as the first data set field name and the second data set field name based on the data naming lineage map with a sensitive private individual data label when the first data set field name incorporates a search term that indicates a private individual data category, wherein the data naming lineage map and the sensitive private individual data label are used track migration of the business data sets containing sensitive personal information during execution of the runtime code instructions generated for the end to end business integration process; and
the processor executing code instructions of a data integration protection assistance system generating a tracking graphical user interface for tracking migration of at least one data set field value in the business data sets containing sensitive personal information during the execution of the runtime code instructions generated for the end to end business integration process.

17. The information handling system of claim 16 further comprising:
a network interface device transmitting the runtime code instructions for the end to end business integration process to a remote user location for execution of the runtime code instructions of the end to end business integration.

18. The information handling system of claim 16 further comprising:
the processor executing code instructions of the data integration protection assistance system generating the tracking graphical user interface displaying a description of the renaming of the data set field value during the end to end business integration process.

19. The information handling system of claim 16 further comprising:
the processor executing code instructions of the data integration protection assistance system generating the tracking graphical user interface displaying a description of a process performed on the data set field value within the runtime code instructions of the end to end business integration process.

20. The information handling system of claim 16 further comprising:
the processor executing an editing of the code instructions for the mapping process-representing visual element in the end to end data integration process to encrypt at least a portion of at least one data set field value in the business data sets to be migrated.
